(19) United States
(12) Patent Application Publication
(10) Pub. No.: US 2023/0086805 A1
(43) Pub. Date: Mar. 23, 2023

(54) PLASTIC PROCESSING SYSTEM AND APPARATUS

(71) Applicant: NILO Global Limited, Auckland (NZ)

(72) Inventor: Philip Kenneth Coveny, Auckland (NZ)

(21) Appl. No.: 17/420,374

(22) PCT Filed: Jun. 10, 2021
(86) PCT No.: PCT/IB2021/055135

§ 371 Date: Jul. 1, 2021

(30) Foreign Application Priority Data
Jun. 10, 2020 (AU) 2020901898
Jun. 10, 2020 (AU) 2020901899

(51) Int. Cl. C04B 26/02; C04B 18/18

(52) U.S. Cl. CPC C04B 26/02; C04B 18/18; C04B 2111/00017

(57) ABSTRACT

Described is a method of manufacturing a binder and the use of the binder to manufacture a roading mixture through mixing with aggregate, or a composite plastic product through the mixture of binder with particulate matter and/or fibre. The binder comprises mixing a plastic with two or more ethylenically unsaturated monomers in a mixing tank. The two or more ethylenically unsaturated monomers may have different homopolymer glass transition temperatures (TO wherein a first monomer structural unit has a homopolymer T_{g} of greater than 80° C. and a second monomer having a homopolymer T_{g} of less than 80° C. The plastic may be selected from a plastic comprising a styrene homopolymer, a styrene copolymer, a copolymer of an alkene and vinyl acetate, acrylic polymer and nylon based polymers or co-polymers, polyester-based thermoplastic polymer resin, propylene-based thermoplastic polymer and homo-polymer of an alkene or combination thereof.

### CROSS-REFERENCE TO RELATED APPLICATION

A claim for priority to the Jun. 10, 2021 filing date of International Application No. PCT/IB2021/055135 ('135 PCT Application), titled PLASTIC PROCESSING SYSTEM AND APPARATUS, which claims priority to AU Patent Application No. 2020901898 ('898 Application), filed Jun. 10, 2020 and AU Patent Application No. 2020901899 ('899 Application), filed Jun. 10, 2020. The entire disclosures of the '135 PCT application, '898 Application, and '899 Application are hereby incorporated herein in their entireties.

### FIELD OF THE INVENTION

The present invention relates to a system and apparatus for processing plastic.

### BACKGROUND TO THE INVENTION

Plastic waste has reached epidemic proportion with waste plastic now found practically on every area of the world, including in deep ocean trenches. According to National Geographic, half of all plastics ever manufactured have been made in the last 15 years with production having increased exponentially from 2.3 million tons in 1950 to 448 million tons by 2015. Production is expected to double by 2050. Approximately 8 million tons of plastic waste escapes into the oceans from coastal nations. Plastics can take up to 400 years to break down, but perhaps most troubling is the production of microplastics which are formed when plastics gradually break down.

While plastic recycling is well known, many countries have low recycling rates and even in those countries that do recycle, it is typically an uneconomic process and may require extensive processing, such as to remove organic matter from the plastic.

It is an object of the present invention to provide a process for processing plastic, to overcome any of the above-mentioned disadvantages, or to at least provide the public with a useful choice.

### SUMMARY OF THE INVENTION

In a first aspect there is described a method of manufacturing a plastic-containing binder comprising providing a plastic source, the plastic source comprising
a) at least 30% by weight of total plastic of a plastic that comprises a styrene unit, or
b) a first plastic that comprises a styrene based monomer and a further plastic that comprises a plastic selected from a styrene copolymer, a copolymer of an alkene and vinyl acetate, acrylic polymer and nylon based polymers or co-polymers, or combination thereof
wherein in the case of (a) the binder further comprises an acrylate monomer, and a cross-linker; and in the case of (b) the binder further comprises a solvent selected from an organohalide solvent, an aromatic hydrocarbon solvent, a mineral spirit, a dearomatised solvent or a combination thereof.

In a first aspect there is described a method of manufacturing a plastic-containing binder composition comprising
mixing a plastic source with a solvent, the solvent selected from a non-reactive solvent or a reactive solvent,
the non-reactive solvent selected from an organohalide solvent, an aromatic hydrocarbon solvent, a mineral spirit, a dearomatised solvent or a combination thereof, and the reactive solvent selected from two or more monoethylenically unsaturated monomers, and
wherein if a non-reactive solvent is used, the plastic source comprises a further plastic that comprises a plastic selected from a styrene copolymer, a copolymer of an alkene and vinyl acetate, acrylic polymer and nylon based polymers or co-polymers, or combination thereof.

In a further aspect there is described a method of manufacturing a plastic-containing binder composition comprising
mixing a plastic source with
a) a solvent selected from an organohalide solvent, an aromatic hydrocarbon solvent, a mineral spirit, a dearomatised solvent or a combination thereof, or
b) a mixture of two or more monomer structural units, each unit having a different homopolymer glass transition temperature (T_{g}), in combination with a curing aid,
wherein a first monomer structural unit has a homopolymer T_{g} of greater than 80° C. and a second monomer having a homopolymer T_{g} of less than 80° C., and
wherein if (a) is present, the plastic source further comprises a plastic that comprises a styrene copolymer, a copolymer of an alkene and vinyl acetate, acrylic polymer and nylon based polymers or co-polymers, or combination thereof.

In a further aspect there is described a method of manufacturing a plastic-containing binder composition comprising
mixing a plastic source with a solvent,
   the plastic source comprising a first plastic that comprises a styrene unit and a further plastic that comprises a plastic selected from a styrene copolymer, a copolymer of an alkene and vinyl acetate, acrylic polymer and nylon based polymers or co-polymers, or combination thereof,
   the solvent selected from an organohalide solvent, an aromatic hydrocarbon solvent, a mineral spirit, a dearomatised solvent or a combination thereof;
to produce a plastic-containing binder composition.

In a further aspect there is described a method of manufacturing a plastic-containing binder composition comprising
mixing a plastic source with a solvent,
   the plastic source comprising at least 30% by weight of total plastic of a styrene based monomer and up to 70% by weight of total plastic of a plastic selected from a styrene copolymer, a copolymer of an alkene and vinyl acetate, acrylic polymer and nylon based polymers or co-polymers or combination thereof,
   the solvent selected from an organohalide solvent, an aromatic hydrocarbon solvent, a mineral spirit, a dearomatised solvent or a combination thereof;
to produce a plastic-containing binder composition.

In a further aspect there is described a method of manufacturing a plastic-containing binder composition comprising
mixing in a mixing tank a composition consisting essentially of a plastic source and a solvent,
   the plastic source comprising at least 30% by weight of total plastic of a plastic having a styrene unit and up to 70% by weight of total plastic of a plastic selected from a styrene copolymer, a copolymer of an alkene and vinyl acetate, acrylic polymer and nylon based polymers or co-polymers,
   the solvent selected from an organohalide solvent, an aromatic hydrocarbon solvent, a mineral spirit, a dearomatised solvent or a combination thereof;
to produce a plastic-containing binder composition.

In a further aspect there is described a method of manufacturing a plastic-containing binder composition comprising
mixing in a mixing tank a composition consisting essentially of a plastic source, a solvent and an additive,
   the plastic source comprising at least 30% by weight of total plastic of a plastic having a styrene unit and up to 70% by weight of total plastic of a plastic selected from a styrene copolymer, a copolymer of an alkene and vinyl acetate, acrylic polymer and nylon based polymers or co-polymers,
   the solvent selected from an organohalide solvent, an aromatic hydrocarbon solvent, a mineral spirit, a dearomatised solvent or a combination thereof, and
   the additive comprising up to 20% of the composition, and selected from the group consisting of paint, oil, marine waste plastic, propylene-based thermoplastic polymer, homo-polymer of an alkene, organic matter, and any combination thereof;
to produce a plastic-containing binder composition.

In a further aspect there is described a method of manufacturing a plastic-containing binder comprising
mixing a plastic source with solvent in a mixing tank, the plastic source selected from:
   a) plastic particles with an average particle size of greater than 8 mm,
   b) plastic particles with an average particle size of less than 8 mm,
   c) any combination of (a) and (b), and
the solvent selected from water, organohalide solvent, an aromatic hydrocarbon solvent, a mineral spirit, a dearomatised solvent or a combination thereof:
optionally providing a homogenizer in fluid communication with the mixing tank, provided the homogenizer is present if (a) is present, or if the mixture includes any particles having a mean diameter greater than 8 mm;
to produce a plastic-containing binder.

In a further aspect there is described a method of manufacturing a plastic-composite product comprising
mixing a water-based binder, solvent-based binder, and a particulate or fibrous substrate to produce a mouldable mixture,
   the water-based binder comprising a mixture of a first plastic source and water, the first plastic source selected from polyester-based thermoplastic polymer resin, propylene-based thermoplastic polymer and homo-polymer of an alkene having a particle size of less than 0.5 mm,
   the solvent-based binder comprising a mixture of a second plastic source and a solvent selected from an organohalide solvent, an aromatic hydrocarbon solvent, a mineral spirit, a dearomatised solvent or a combination thereof, the second plastic source comprising at least 30% by weight of total plastic of the second plastic source of a plastic having a styrene unit and up to 70% by weight of total plastic of the second plastic source selected from a styrene copolymer, a copolymer of an alkene and vinyl acetate, acrylic polymer and nylon based polymers or co-polymers,
introducing the mixture into a mould, and
compressing the mixture to produce the plastic-composite product.

In a further aspect there is described a method of manufacturing a plastic-containing binder comprising
mixing a plastic source with water in a mixing tank, the plastic source selected from:
   a) plastic particles with an average particle size of greater than 0.5 mm,
   b) plastic particles with an average particle size of less than 0.5 mm,
   c) any combination of (a) and (b), and
the plastic source selected from polyester-based thermoplastic polymer resin, propylene-based thermoplastic polymer, homo-polymer of an alkene or a combination thereof:
optionally providing a homogenizer in fluid communication with the mixing tank, provided the homogenizer is present if (a) is present, or if the mixture includes any particles having a mean diameter greater than 0.5 mm;
to produce a plastic-containing binder.

In a further aspect there is described a plastic-composite product comprising a plastic-based binder and a particulate or fibrous substrate,
the plastic-based binder comprising a plastic source selected from polyester-based thermoplastic polymer resin, propylene-based thermoplastic polymer and homo-polymer of an alkene having a particle size of less than 0.5 mm,
the binder having been formed as a mixture of the plastic source and a water-based solvent that upon mixing with the particulate or fibrous substrate and curing produces the plastic-composite product.

In a further aspect there is described a method of processing plastic comprising
mixing a source of plastic with a solvent in a mixing tank to produce a plastic mix, wherein the source of plastic is selected from:
   a) plastic having a styrene unit, styrene copolymer, a copolymer of an alkene and vinyl acetate, acrylic polymer and nylon based polymers or co-polymers,
   b) polyester-based thermoplastic polymer resin, propylene-based thermoplastic polymer and homo-polymer of an alkene, or
   c) any combination of (a) to (d); and
wherein the solvent is selected from
   water if a plastic of (b) is present,
   an organohalide solvent, an aromatic hydrocarbon solvent, a mineral spirit, a dearomatised solvent or a combination thereof if (a) is present;
optionally providing a homogenizer in fluid communication with the mixing tank, provided the homogenizer is present if the mixture includes any particles having a mean diameter greater than 0.5 mm;
to produce a plastic slurry; and
providing the plastic slurry into a solvent recovery system to produce an emulsion comprising less than 30% solvent.

In a further aspect there is described a method of manufacturing a plastic composite product comprising
mixing a plastic source with solvent in a mixing tank, the plastic source selected from:
   a) plastic particles with an average particle size of greater than 0.5 mm,
   b) plastic particles with an average particle size of less than 0.5 mm,
   c) any combination of (a) and (b), and
the solvent selected from water, organohalide solvent, an aromatic hydrocarbon solvent, a mineral spirit, a dearomatised solvent or a combination thereof:
optionally providing a homogenizer in fluid communication with the mixing tank, provided the homogenizer is present if (a) is present, or if the mixture includes any particles having a mean diameter greater than 0.5 mm;
to produce a plastic-containing binder, and
mixing the plastic-containing binder with a particulate or fibrous substrate to form a plastic composite product.

In a further aspect there is described a method of manufacturing a road comprising
providing a plastic-containing binder comprising a plastic source and a solvent,
   the plastic source comprising at least 30% by weight of total plastic of plastic having a styrene unit and up to 70% by weight of total plastic of a plastic selected from a styrene copolymer, a copolymer of ethylene and vinyl acetate, acrylic polymer and nylon based polymers or co-polymers,
   the solvent selected from an organohalide solvent, an aromatic hydrocarbon solvent, a mineral spirit, a dearomatised solvent or a combination thereof
combining the plastic-containing binder with a coarse aggregate, the coarse aggregate having a particle size of less than about 60 mm,
laying the mixture onto a roading base course at a thickness of between 50 to about 200 mm; and
compacting the layer.

In a further aspect there is described a method of manufacturing a roading substrate comprising
providing a binder comprising,
   a plastic source comprising at least 30% by weight of total plastic of a plastic having a styrene unit,
   an acrylate monomer,
   a cross-linker, and
combining the binder with an aggregate to coat said aggregate.

In a further aspect there is described a method of manufacturing a road comprising
providing a binder comprising,
   a plastic source comprising at least 30% by weight of total plastic of a plastic having a styrene unit,
   an acrylate monomer,
   a cross-linker, and
combining the binder with an aggregate to coat said aggregate,
laying the mixture onto a roading base course at a thickness of between 50 to about 200 mm; and
compacting the layer.

In a further aspect there is described a solvent recovery system comprising a heatable solvent chamber having an inlet for receiving a plastic-containing solvent based slurry and a heating system that can heat solvent (of the plastic-containing solvent based slurry) in the solvent chamber, the solvent recovery system including an outlet from the solvent chamber for receiving evaporated solvent that passes to an outlet pipe that is held at a temperature to assist condensing of the evaporated solvent such that the evaporated solvent passes to a receiving tank.

In a further aspect there is described a binder formulation manufactured by any one of the above methods.

Any one or more of the following embodiments may relate to any of the aspects described herein or any combination thereof.

In one configuration the binder further comprises a promotor for the cross-linker.

In one configuration the cross-linker is multifunctional. Preferably it is trifunctional.

In one configuration the cross-linker is selected from trimethylol propane Triacrylate and a peroxide cross-linker.

In one configuration the promotor is an amine based compound. In one configuration the promotor is an aniline derivative or analouge.

In one configuration the promotor is selected from N,N-dimethyl-p-toluidine (DMPT), N,N-dieethyl-p-toluidine (DEPT) or a combination thereof.

In one configuration the binder comprises a styrene monomer.

In one configuration the styrene monomer is polystyrene.

In one configuration the styrene copolymer is a polymer of styrene and acrylonitrile. In one embodiment the styrene copolymer is acrylonitrile butadiene styrene (ABS).

In one configuration the copolymer of an alkene is a copolymer of ethylene.

In one embodiment the copolymer of ethylene and vinyl acetate is ethylene-vinyl acetate (EVA).

In one configuration the acrylic polymer is poly(methyl methacrylate).

In one configuration the nylon based polymers or co-polymers is Nylon.

In one configuration the polyester-based thermoplastic polymer resin is polyethylene terephthalate (PET).

In one embodiment the propylene-based thermoplastic polymer is polypropylene (PP).

In one embodiment the homo-polymer of an alkene is a homo-polymer of ethylene.

In one embodiment the homo-polymer of ethylene is polyethylene (PE) (including high and low density polyethylene).

In one embodiment the organohalide solvent is an organochloride solvent. In one embodiment the organochloride solvent is methyl chloride, methylene chloride or trichloroethylene, or a combination thereof

In one embodiment the aromatic hydrocarbon solvent is selected from toluene or xylene, or a combination thereof.

In one embodiment the dearomatised solvent is selected from Exxsol™ D40, Exxsol™ D60, Exxsol™ D80 or Exxsol™ D100, ShellSol D60, or a combination thereof.

In one configuration the paint is selected from acrylic paint, oil-based paint or water based paint.

In one configuration the oil is selected from petroleum based oil, synthetic oil, vegetable oil or a combination thereof.

In one embodiment the organic matter is residual organic matter.

In one embodiment the additive comprises 1, 2, 3, 4, 5, 6, 7, 8, 9, 10, 11, 12, 13, 14, 15, 16, 17, 18, 19 or 20% of the binder composition, and suitable ranges may be selected from between any of these values.

In one configuration the roading composition is absent any bitumen.

In one configuration the plastic source comprises high melt plastic.

In one configuration the high melt plastic is selected from polyester-based thermoplastic polymer resin, propylene-based thermoplastic polymer, homo-polymer of ethylene, or a combination thereof.

In one configuration the composition comprises a high melt plastic, and during, or after combining with aggregate, is heated to about 100, 110, 120, 130, 140, 150, 160, 170, 180, 190 or about 200° C., and suitable ranges may be selected from between any of these values.

In one configuration the plastic source is selected from ABS, nylon, EVA or acrylic, or a combination thereof.

In one configuration the ABS, nylon, EVA or acrylic is dissolved in the solvent.

In one configuration the ABS, nylon, EVA or acrylic is dissolved prior to adding to the mixing tank.

In an alternative configuration the ABS, nylon, EVA or acrylic is dissolved in the mixing tank.

In one configuration the additive is present at less than 10% by weight of the composition.

In one configuration the acrylate monomer is selected from a soft monomer.

In one configuration the acrylate monomer is selected from a hard monomer.

In one configuration the hard acrylate monomer is selected from methyl methacrylate, or a styrene monomer.

In one embodiment the soft acrylate monomer is selected from an ethyl hexyl acrylate (such as 2-ethyl hexyl acrylate).

In one configuration the cross-linker is multifunctional. Preferably it is trifunctional.

In one configuration the cross-linker is selected from trimethylol propane Triacrylate and a peroxide cross-linker.

In one configuration the promotor is an amine based compound. In one configuration the promotor is an aniline derivative or analouge.

In one configuration the promotor is selected from N,N-dimethyl-p-toluidine (DMPT), N,N-dieethyl-p-toluidine (DEPT) or a combination thereof.

In one configuration the binder comprises a mixture of hard and soft acrylate monomers.

In one configuration the binder comprises about 0.2, 0.25, 0.3, 0.35, 0.4, 0.45 or 0.5% by weight of a promotor, and suitable ranges may be selected from between any of these values.

In one configuration the binder comprises about 1, 2, 3, 4 or 5% cross-linker, and suitable ranges may be selected from between any of these values.

In one configuration the binder is combined with aggregate.

In one configuration the roading composition comprises the binder and aggregate. In one embodiment the roading composition comprises about 7, 8, 9, 10, 11 or 12% binder, and suitable ranges may be selected from between any of these values.

In one configuration the roading composition comprises the binder and aggregate at a ratio of binder to aggregate of 1:8 to about 1:14, and suitable ranges may be selected from between any of these values.

In one configuration a road is formed of a base layer formed of the plastic-containing roading binder composition in combination with an aggregate.

In one configuration the thickness of the road sub-base layer is 120, 130, 140, 150, 160, 170, 180, 190 or 200 mm, and suitable ranges may be selected from between any of these values.

In one configuration the mixing tank comprises a mixture of water and a non-aqueous solvent.

In one configuration the non-aqueous solvent is selected from an organohalide solvent, an aromatic hydrocarbon solvent, a mineral spirit, a dearomatised solvent or a combination thereof.

In one configuration the ratio of water to non-aqueous solvent is about 60:40 to about 40:60.

In one configuration the styrene is copolymerised with a soft monomer.

In one configuration the ABS, Nylon, EVA or acrylic or combination thereof comprise about 40 to about 70% by weight of the plastic source.

In one configuration the ABS or acrylic increases the malleability of the product or roading substrate.

In one configuration the plastic source comprises PVC.

In one configuration the plastic substrate comprises about 1 to about 5% by weight of the plastic source of PVC.

In one configuration the PVC increases the ductility of the product or roading substrate.

In one configuration the plastic source comprises at least 30% by weight of polystyrene based on the amount of total plastic and one plastic selected from a styrene copolymer, a copolymer of ethylene and vinyl acetate, acrylic polymer and nylon based polymers or co-polymers.

In one configuration the plastic source comprises at least 30% by weight of polystyrene based on the amount of total plastic and at least two different plastics selected from a styrene copolymer, a copolymer of ethylene and vinyl acetate, acrylic polymer and nylon based polymers or co-polymers.

In one configuration the plastic source comprises at least 30% by weight of polystyrene based on the amount of total plastic and at least three different plastics selected from a styrene copolymer, a copolymer of ethylene and vinyl acetate, acrylic polymer and nylon based polymers or co-polymers.

In one configuration the plastic source comprises (based on the total amount of plastic in the binder)
30% by weight of polystyrene,
70% by weight of ABS, EVA or acrylic.

In one configuration the plastic source comprises (based on the total amount of plastic in the binder)
30% by weight of polystyrene,
25% by weight of ABS
25% by weight of EVA
20% by weight of acrylic.

In one configuration the plastic source comprises (based on the total amount of plastic in the binder)
40% by weight of polystyrene,
60% by weight of ABS, EVA or acrylic.

In one configuration the plastic source comprises (based on the total amount of plastic in the binder)
40% by weight of polystyrene,
20% by weight of ABS
20% by weight of EVA
20% by weight of acrylic.

In one configuration the plastic source comprises (based on the total amount of plastic in the binder)
50% by weight of polystyrene,
50% by weight of ABS, EVA or acrylic.

In one configuration the plastic source comprises (based on the total amount of plastic in the binder)
50% by weight of polystyrene,
20% by weight of ABS
20% by weight of EVA
10% by weight of acrylic.

In one configuration the plastic source comprises (based on the total amount of plastic in the binder)
60% by weight of polystyrene,
40% by weight of ABS, EVA or acrylic.

In one configuration the plastic source comprises (based on the total amount of plastic in the binder)
60% by weight of polystyrene,
15% by weight of ABS
15% by weight of EVA
10% by weight of acrylic.

In one configuration the plastic source comprises (based on the total amount of plastic in the binder)
30% by weight of polystyrene,
50% by weight of ABS, EVA or acrylic, and
20% by weight of PVC.

In one configuration the plastic source comprises (based on the total amount of plastic in the binder)
30% by weight of polystyrene,
60% by weight of ABS, EVA or acrylic, and
10% by weight of PVC.

In one configuration the plastic source comprises (based on the total amount of plastic in the binder)
30% by weight of polystyrene
40% by weight of polyethylene,
10% by weight of acrylic,
10% by weight of EVA, and
10% by weight of organic peroxide.

In one configuration the non-aqueous solvent comprises
about 50% methylene chloride by weight,
about 40% toluene by weight, and
q.s. white spirits, or trichloroethylene or a combination thereof.

In one configuration the mixing tank is heated to a temperature of up 30° C.

In one configuration the roading process includes a surface layer of plastic.

In one configuration the road surface layer of plastic is formed from a plastic slurry comprising particulate PET having a particle size of less than 8 mm in a carrier.

In one configuration the road surface layer of plastic is about 50 mm to about 100 mm in thickness.

In one configuration the source plastic comprises a plastic having a melting point above 105° C. to about 160° C.

In one configuration the high melt plastic is selected from polyethylene, PET, polypropylene, nylon, or a combination thereof.

In one configuration about 5% to about 15% by weight of high melt plastic is combined with the aggregate.

In one configuration the plastic binder is heated to a temperature of up to 30° C. when in the mixing tank.

In one configuration the plastic-aggregate mixture is heated to a temperature of up to 100° C. to 200° C.

In one configuration the heated plastic-aggregate mixture is combined with non-recyclable plastics, wherein the ratio of non-recyclable plastics to high-melt plastic is about 40:60.

In one configuration a colorant is added to the mixture.

In one configuration the cold roading system comprises a source of plastic selected from styrene, ABS, nylon, PVC or a combination thereof.

In one configuration the first tank comprises a plastic and solvent mixture which comprises a ratio of plastic to solvent of about 60:40 to about 40:60.

In one configuration the solvent comprises
about 40% by weight methylene,
about 10% by weight trichloroethylene,
about 10% by weight toluene,
about 0.4% by weight of the solvent of an enzymatic detergent, and
q.s. white spirit.

In one configuration a particulate plastic is added to the mixing tank.

In one configuration the particulate plastic comprises about 15% to about 85% by weight of the total amount of plastic.

In one configuration the particulate plastic is selected from PET, polypropylene or a polyethylene (including high and low density), or a combination thereof.

In one configuration the particulate plastic is selected from PVC.

In one configuration the particulate plastic has a particle size of less than about 8 mm.

In one configuration the composite product is a concrete-composite product, a wood-based composite product.

In one configuration the composite product is a panel, post or block.

In one configuration the wood-based composite product is selected from plywood, particle board, and medium density board.

In one configuration the particulate or fibrous substrate has a particle size of less than about 10 mm.

In one configuration the particulate or fibrous substrate has a length of less than 50 mm.

In one configuration the particulate or fibrous substrate is selected from wood particles (e.g. sawdust or wood fibres or flakes), shredded paper or cardboard fibre, shredded polyethylene woven bags, shredded polyethylene bags, chipped PET bottles, crushed Glass, crushed consumables (e.g. crushed plastic toys, electronics, printer cartridges), volcanic ash and pot ash, granulated rubber, granulated tyres or a combination thereof.

In one configuration the plastic-containing binder and particulate or fibrous substrate is mixed and placed into a mould.

In one configuration the plastic-composite product comprises less than 15, 14, 13, 12, 11, 10, 9, 8, 7, 6, 5, 4, 3, 2 or 1% free water. As used herein, the phrase “free water” means water that is not bound to another molecule by chemical bonding (e.g. hydrogen bonding or covalent bonding).

In one configuration the homogenizer comprises:
an inlet, configured to receive a flow of slurry, the slurry comprising particles having a particle size of less than 20 mm,
an outlet,
three or more cylindrical bodies, the pair of cylindrical bodies comprising an inner cylindrical body and an outer cylindrical body that rotate relative to each other, each cylindrical body comprising a plurality of apertures to define a flow path through each cylindrical body, and
wherein the slurry traverses the flow path from the homogenizer inlet to the homogenizer outlet via the at least one aperture of each cylindrical body to produce an outlet slurry.

In one configuration the system comprises 3, 4, 5, 6, or 7 cylindrical bodies.

In one configuration the solvent recovery system inlet comprises one or more valves to control the entry of solvent into the heatable solvent chamber.

In one configuration the heatable solvent chamber includes a sealed lid such that the heatable solvent chamber is air tight.

In one configuration the heating system is a jacket heater or coil heater.

In one configuration the heatable solvent chamber comprises a thermostat to control the temperature of the solvent in the heatable solvent chamber, to control the rate at which the solvent is vaporised.

In one configuration the heatable solvent chamber comprises a suction head that receives evaporated solvent.

In one configuration the outlet pipe comprises a chiller.

In one configuration the solvent recovery system comprises a vacuum fan.

In one configuration the solvent recovery system comprises a vacuum tube comprising a vacuum created by the vacuum fan, the vacuum tube fluidly connected to the outlet tube and the receiving tank.

In one configuration the inlet into the vacuum tube comprises a protective tongue placed on or about the inlet to prevent movement of evaporated solvent to the vacuum fan.

In one configuration the solvent recovery system removes at least 70, 75, 80, 85, 90, 95 or 98% of the solvent from the slurry introduced into the heatable solvent chamber, and suitable ranges may be selected from between any of these values.

In one configuration the solvent recovery unit extracts at least 80 to about 95% of the liquid solvent (water and non-aqueous solvent) from the homogenised mixture.

In one configuration the mixture passes through at least two homogenizers.

As used herein, the phrase “comprises a styrene unit” means a plastic polymer that is a homopolymer of copolymer of styrene. That is, if a homopolymer then it solely contains styrene monomer units to form polystyrene. If a co-polymer then it contains at least one styrene monomer unit.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7).

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

The term “comprising” as used in this specification means “consisting at least in part of”. When interpreting statements in this specification which include that term, the features, prefaced by that term in each statement, all need to be present but other features can also be present. Related terms such as “comprise” and “comprised” are to be interpreted in the same manner.

### BRIEF DESCRIPTION OF THE DRAWINGS

The invention will now be described by way of example only and with reference to the drawings in which:

FIG. 1 is a flow diagram of the process described herein.

FIG. 2 is a flow diagram of the process described herein.

FIG. 3A shows a view of a macerator as described having two or more bodies, where the bodies are of a cylindrical form.

FIG. 3B shows a cross-sectional view of a macerator as described

FIG. 4 is a solvent recovery system as described.

FIG. 5 is a solvent recovery system as described.

FIG. 6 are graphs showing the point load test results.

FIG. 7A is a graph showing the Resilient Modulus for PM2 and TM2 with varying promotor (DMPT) and cross-linker (BPO) at 10% by weight binder to stones ratio and varying BPO at 0.375% by weight promotor (DMPT).

FIG. 7B is a graph showing the Resilient Modulus for PM2 and TM2 with varying promotor (DMPT) and cross-linker (BPO) at 10% by weight to stones ratio and varying DMPT at 3% by weight cross-linker (BPO).

FIG. 8A is a graph showing the Resilient Modulus for a range of monomer formulations at different binder % by weight at 0.375% by weight promotor (DMPT).

FIG. 8B is a graph showing the Resilient Modulus for a range of monomer formulations at different binder % by weight at 3% by weight cross-linker (BPO).

FIG. 9A is a graph showing the Resilient Modulus for various monomer formulations at 10, 12 or 14% by weight binder relative to stones at 0.375% by weight promotor (DMPT).

FIG. 9B is a graph showing the Resilient Modulus for various monomer formulations at 10, 12 or 14% by weight binder relative to stones at 3% by weight cross-linker (BPO).

FIG. 10A is a graph showing the Resilient Modulus for various monomer formulations at different binder % by weight at 0.375% by weight promotor (DMPT).

FIG. 10A is a graph showing the Resilient Modulus for various monomer formulations at different binder % by weight at 3% by weight cross-linker (BPO).

FIG. 11 is a graph showing the Resilient Modulus for various monomer mix at 10% by weight binder to stones ratio.

### DETAILED DESCRIPTION OF THE INVENTION

Described is a method of preparing a binder and the use of that binder in the manufacture of various products.

The binder may be prepared by providing a plastic source that comprises (a) at least 30% by weight of total plastic of a plastic that contains a styrene unit, or (b) a first plastic that comprises a styrene unit and a further plastic that comprises a plastic selected from a styrene copolymer, a copolymer of an alkene and vinyl acetate, acrylic polymer and nylon based polymers or co-polymers, or combination thereof. In case of (a), the binder further comprises an acrylate monomer, and a cross-linker. In the case of (b), the binder further comprises a solvent selected from an organohalide solvent, an aromatic hydrocarbon solvent, a mineral spirit, a dearomatised solvent or a combination thereof.

The binder may be prepared by mixing a plastic source with a solvent, selected from a non-reactive solvent or a reactive solvent. The non-reactive solvent may be selected from an organohalide solvent, an aromatic hydrocarbon solvent, a mineral spirit, a dearomatised solvent or a combination thereof, and the reactive solvent may be selected from two or more monoethylenically unsaturated monomers. When a non-reactive solvent is used, the plastic source may comprise a further plastic that comprises a plastic selected from a styrene copolymer, a copolymer of an alkene and vinyl acetate, acrylic polymer and nylon based polymers or co-polymers, or combination thereof.

The binder may be prepared by mixing a plastic source with (a) a solvent selected from an organohalide solvent, an aromatic hydrocarbon solvent, a mineral spirit, a dearomatised solvent or a combination thereof, or (b) a mixture of two or more monomer structural units, each unit having a different homopolymer glass transition temperature (Tg), in combination with a curing aid, wherein a first monomer structural unit has a homopolymer Tg of greater than 80° C. and a second monomer having a homopolymer Tg of less than 80° C. If (a) is present, the plastic source further comprises a plastic that comprises a styrene copolymer, a copolymer of an alkene and vinyl acetate, acrylic polymer and nylon based polymers or co-polymers, or combination thereof.

The binder may be prepared by mixing a plastic source with a solvent. The plastic source may comprise a first plastic that comprises a styrene unit and a further plastic that comprises a plastic selected from a styrene copolymer, a copolymer of an alkene and vinyl acetate, acrylic polymer and nylon based polymers or co-polymers, or combination thereof. The solvent may be selected from an organohalide solvent, an aromatic hydrocarbon solvent, a mineral spirit, a dearomatised solvent or a combination thereof.

The binder may be prepared by mixing a plastic source with a solvent. The plastic source may comprise at least 30% by weight of total plastic of a plastic that contains a styrene unit and up to 70% by weight of total plastic of a plastic selected from a styrene copolymer, a copolymer of an alkene and vinyl acetate, acrylic polymer and nylon based polymers or co-polymers or combination thereof. The solvent may be selected from an organohalide solvent, an aromatic hydrocarbon solvent, a mineral spirit, a dearomatised solvent or a combination thereof.

The binder may be prepared by mixing plastic source and a solvent. The plastic source may comprise at least 30% by weight of total plastic of a plastic that contains a styrene unit and up to 70% by weight of total plastic of a plastic selected from a styrene copolymer, a copolymer of an alkene and vinyl acetate, acrylic polymer and nylon based polymers or co-polymers. The solvent may be selected from an organohalide solvent, an aromatic hydrocarbon solvent, a mineral spirit, a dearomatised solvent or a combination thereof.

The binder may be prepared by mixing a plastic source, a solvent and an additive. The plastic source may comprise at least 30% by weight of a plastic that contains a styrene unit and up to 70% by weight of total plastic of a plastic selected from a styrene copolymer, a copolymer of an alkene and vinyl acetate, acrylic polymer and nylon based polymers or co-polymers. The solvent may be selected from an organohalide solvent, an aromatic hydrocarbon solvent, a mineral spirit, a dearomatised solvent or a combination thereof. The additive may comprise up to 20% of the composition, and be selected from the group consisting of paint, oil, marine waste plastic, propylene-based thermoplastic polymer, homo-polymer of an alkene, organic matter, and any combination thereof.

The binder may be formed by mixing a plastic source with solvent in a mixing tank. The plastic source may be selected from (a) plastic particles with an average particle size of greater than 8 mm, (b) plastic particles with an average particle size of less than 8 mm, or any combination of (a) and (b). The solvent may be selected from water, organohalide solvent, an aromatic hydrocarbon solvent, a mineral spirit, a dearomatised solvent or a combination thereof. If (a) is present, or if the mixture includes any particles having a mean diameter greater than 8 mm, the mixing tank may be in fluid communication with a homogenizer.

The binder may be formed by mixing a water-based binder, solvent-based binder, and a particulate or fibrous substrate to produce a mouldable mixture. The water-based binder may comprise a mixture of a first plastic source and water, the first plastic source selected from polyester-based thermoplastic polymer resin, propylene-based thermoplastic polymer and homo-polymer of an alkene having a particle size of less than 0.5 mm. The solvent-based binder may comprise a mixture of a second plastic source and a solvent selected from an organohalide solvent, an aromatic hydrocarbon solvent, a mineral spirit, a dearomatised solvent or a combination thereof. The second plastic source may comprise at least 30% by weight of total plastic of the second plastic source of a plastic that contains a styrene unit and up to 70% by weight of total plastic of the second plastic source selected from a styrene copolymer, a copolymer of an alkene and vinyl acetate, acrylic polymer and nylon based polymers or co-polymers. The mouldable mixture may be introducing into a mould or press, and compressed to produce a plastic-composite product.

The binder may be prepared by mixing a plastic source with water in a mixing tank, the plastic source selected from (a) plastic particles with an average particle size of greater than 0.5 mm, (b) plastic particles with an average particle size of less than 0.5 mm, any combination of (a) and (b). The plastic source may be selected from a polyester-based thermoplastic polymer resin, propylene-based thermoplastic polymer, homo-polymer of an alkene or a combination thereof. If (a) is present, or if the mixture includes any particles having a mean diameter greater than 0.5 mm, then the mixing tank may be in fluid communication with a homogenizer.

The binder may be formed by
a) dissolving the plastics in a non-reactive solvent, or
b) dissolving the plastics in a reactive monomer solution.

The plastics for dissolution require a suitable solvent. The plastics for dissolving in a reactive monomer solution require a cross-linker to copolymerise the plastics.

Described is a process for processing plastic. The plastic may originate from a range of sources, such as virgin plastic or waste plastic, depending on the process in which it is used.

Waste plastic provides a useful source of plastic for this process. In many countries waste plastic creates an environmental problem as society struggles to recycle or dispose of such plastic economically and safely. The sourced waste plastics may be for example the type of plastics derived from the waste recycling process. However, it will be appreciated various types of input plastic may be used depending on the desired output slurry.

The plastic may be selected from a plastic comprising a styrene based homopolymer, a styrene copolymer, a copolymer of an alkene and vinyl acetate, acrylic polymer and nylon based polymers or co-polymers, polyester-based thermoplastic polymer resin, propylene-based thermoplastic polymer and homo-polymer of an alkene or combination thereof.

The waste plastic can be a mixture of any of polyethylene terephthalate (PETE or PET), high-density polyethylene (HDPE), polyvinyl chloride (PVC), low-density polyethylene (LDPE), polypropylene (PP), polystyrene or styrofoam (PS), polycarbonate, polylactide, acrylic, acrylonitrile butadiene, styrene, fiberglass, rubber, paper and nylon. This waste plastic mixture may for example originate from a comingled plastic waste stream.

Given the wide use of plastic in society, the waste plastic is typically sourced from every-day waste products such as plastic bottles (e.g. milk, carbonated drinks, water bottles, cleaning products), plastic containers (e.g. for industrial products such as oil, food items), and packaging (whether rigid or soft), although it will be appreciated that the product list of waste products is immensely broad.

Waste plastic is typically categorised. For example, plastics are often stamped with a chasing arrows triangle encompassing an identifying number as shown below.

| Category | Plastic | Description of plastic products |
|---|---|---|
| [symbol] | Polyethylene terephthalate | Soft drink bottles, mineral juice, fruit juice container, cooking oil |
| PETE | | |
| [symbol] | High density polyethylene | Milk jugs, cleaning agents, laundry determents, bleaching agents, shampoo bottles, washing and shower soaps |
| HDPE | | |
| [symbol] | Polyvinyl chloride | Trays for sweets, fruit, plastic packaging (bubble foil) and food foils to wrap the foodstuff |
| PVC | | |
| [symbol] | Low-density polyethylene | Crushed bottles, shopping bags, highly-resistant sacks and most of the wrappings |
| LDPE | | |
| [symbol] | Polypropylene | Furniture, consumers luggage, toys, as well as bumpers, lining and external borders of cars, yoghurt and margarine tubs |
| PP | | |
| [symbol] | Polystyrene | Toys, hard packing, refrigerator trays, cosmetic bags, costume jewellery, CD cases, vending cups |
| PS | | |
| [symbol] | Acrylic, polycarbonate, polyactic fibres, nylon, fibreglass | Large water bottles, some juice bottles |
| OTHER | | |

One source of plastic may be shredded plastic. Shredded plastic may be shredded to a particle size of less than about 20 mm.

Plastic particles may be measured by direct imaging using light microscopy. Samples may first be analysed by laser diffraction technique using a CILAS 1180, to have a general idea of the particle size distribution. A suspension of plastic may be placed in a Sedgewick Rafter cell (SRC) etched with a 50 column by 20 row grid. Size and particle count measurements may be determined at 100× and 200× magnifications with an Olympus BX 51 calibrated eyepiece binocular microscope with QCapture Pro 5.1 imaging software. For each sample three replicates may be used and the longest length of the first 100 particles in 6 randomly selected transects measured. To determine particle size distribution, 300 particles from each sample may be measured. The lengths may be manually determined with an ocular calibrated micrometer and the values were converted to microns or mm.

Flow cytometry may be used to analyse particles in the sub 70 μm range.

The shredded plastic has a particle size of about 2, 3, 4, 5, 6, 7, 8, 9, 10, 11, 12, 13, 14, 15, 16, 17, 18, 19 or 20 mm, and suitable ranges may be selected from between any of these values, (for example, about 2 to about 20, about 2 to about 18, about 2 to about 15, about 2 to about 10, about 2 to about 8, about 3 to about 20, about 3 to about 17, about 3 to about 16, about 3 to about 12, about 3 to about 10, about 3 to about 7, about 4 to about 20, about 4 to about 18, about 4 to about 14, about 4 to about 10, about 4 to about 8, about 5 to about 20, about 5 to about 19, about 5 to about 15, about 5 to about 10, about 6 to about 20, about 6 to about 17, about 6 to about 13, about 6 to about 10, about 7 to about 20, about 7 to about 18, about 7 to about 16, about 7 to about 10, about 8 to about 20, about 8 to about 18, about 8 to about 15, about 8 to about 10, about 9 to about 20, about 9 to about 16, about 9 to about 14, about 10 to about 20, about 10 to about 17, about 11 to about 20, about 11 to about 17, about 12 to about 20, about 12 to about 18 or about 13 to about 20 mm).

Various methods are known to reduce the original plastic products to a particle size as described above. For example, the use of cutting and/or extruders, shredders, granulators or grinders. Cutting and extruding machines (e.g. see U.S. Pat. No. 9,744,689) can include one or more knives that rotate in a housing such that any plastic introduced into the housing is cut by the knives into smaller particles. In some machines the plastic may start to melt, or melt, due to the action of the knives (i.e. by the heat produced by friction) and such melted or partially melted plastic may enter an extruder in which the screws carry the plastic away from the cutting blades. The plastic may then be extruded and cut into small pallets at the outlet of the extruder.

Shredders (e.g. see U.S. Pat. No. 6,241,170), granulators (e.g. see U.S. Pat. No. 6,749,138) and grinders (e.g. see U.S. Pat. No. 5,547,136 or German patent DE 19614030 A1) may include a single or plurality of cutting wheels or rollers that again rotate in a housing and reduce the size of the plastic through the action of the cutting wheel or rollers against the plastic as the plastic passes between the cutting wheels or roller and the internal surface of the housing. Alternately, the plastic may pass between two or more banks of knives or rollers, that in some cases overlap, such that the plastic is cut or ground due to this passage.

Such processes typically use rotary knives or bed knives whose rotation cuts the plastic into smaller particles or pieces.

A further source of plastic could include a homogenised slurry of plastic having a particle size of less than 2 mm. Preferably the homogenised plastic has a particle size of less than about 0.05, 0.1, 0.2, 0.3, 0.4, 0.5, 1, 2 mm, and suitable ranges may be selected from between any of these values, (for example, about 0.05 to about 2, about 0.05 to about 1, about 0.05 to about 0.5, about 0.1 to about 2, about 0.1 to about 1, about 0.1 to about 0.5, about 0.2 to about 2, about 0.2 to about 1, about 0.2 to about 0.5, about 0.3 to about 2, about 0.3 to about 1, about 0.3 to about 0.5, about 0.4 to about 2 or about 0.4 to about 1 mm).

An example of a homogenizer to achieve the above is the use of a macerator having two or more cylindrical concentric bodies that rotate relative to each other. This is described in Section 4 below. Plastic for use in such a macerator may include HDPE, LDPE, PETE, PVC, PE, PP or combination thereof.

The emulsion produced may be a plastic suspended in the carrier. The carrier can be selected from a range of different solvents, such as water or organic solvents. Suitable solvents to form the slurry include a haloalkane (for example methyl chloride).

A further source of plastic is dissolved plastic, such as a dissolved polystyrene.

Styrene is also known as ethenylbenzene, vinylbenzene, or phenylethene. The styrene based monomer can be polymerised (facilitated by the vinyl group) to form a homo- or copolymer. For example, the styrene based monomer may polymerise as a homopolymer to form polystyrene.

The styrene based monomer may form a co-polymer with one or more other compounds. For example,
with acrylonitrile in the presence of polybutadiene for example to form acrylonitrile butadiene styrene (ABS),
with butadiene for example to form styrene-butadiene or styrene-isoprene-styrene,
with ethylene and/or butylene for example to form styrene-ethylene-butylene-styrene (S-BE-S),
with divinylbenzene for example to form styrene-divinylbenzene (S-DVB),
with acrylonitrile to for example form styrene acrylonitrile (SAN),
with unsaturated polyesters that are typically used in resins and thermosetting compounds.

Styrene polymers are used to make latex, synthetic rubber, and polystyrene resins which are then used to make plastic packaging, disposable cups and containers, insulation, and other products. Styrene polymers are also used to make solid and film polystyrene (used in rigid foodservice containers), CD cases, appliance housings, envelope windows, polystyrene foam (used in food service products and building insulation), tub and shower enclosures, automobile body panels, wind turbine parts, boats, ABS plastic (used in refrigerator liners) small household appliances and luggage.

The styrene polymer may first be dissolved in an organic solvent such as chlorinated aliphatic hydrocarbons, organohalide solvent, aromatic hydrocarbon solvent, a mineral spirit, methyl ethyl ketone, ethyl acetate. Examples of suitable organic solvents include acetone, dichloroethane, tetrahydrofuran and toluene.

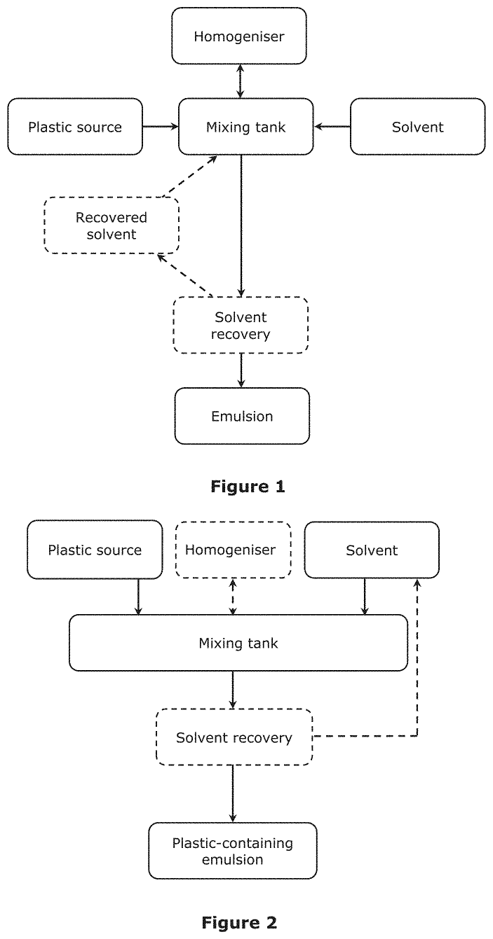

For example, the styrene polymer can be introduced into a tank that contains a suitable solvent. Once the styrene polymer is suitably dissolved, it can then be pumped to a mixing tank as shown in FIG. 1.

The plastic formed from a styrene based monomer is combined with another plastic selected from a plastic selected from a styrene copolymer, a copolymer of ethylene and vinyl acetate, acrylic polymer and nylon based polymers or co-polymers.

The styrene copolymer may be a polymer of styrene and acrylonitrile, such as acrylonitrile butadiene styrene (ABS). Given the binder is a combination of two or more different plastics, where one of the plastics is a polymer of styrene and acrylonitrile, the other plastic polymer is not a polymer of styrene and acrylonitrile.

The copolymer of an alkene may be a copolymer of ethylene. The copolymer of ethylene may be, for example, a copolymer of ethylene and vinyl acetate. The copolymer of ethylene and vinyl acetate may be ethylene-vinyl acetate (EVA).

The acrylic polymer may be poly(methyl methacrylate).

The nylon based polymers or co-polymers are typically aliphatic or semi-aromatic polyamides.

The polyester-based thermoplastic polymer resin may be polyethylene terephthalate (PET). The propylene-based thermoplastic polymer may be polypropylene (PP). The homo-polymer of an alkene may be a homo-polymer of ethylene. The homo-polymer of ethylene may be polyethylene (PE)(including high and low density polyethylene).

In some configurations the plastic may be a virgin plastic. In such a case it may be necessary to add a cross linker to the virgin plastic as is done during the thermosetting process for plastic products. Common cross linkers lead to cross-linking based on peroxide cross-linking, radiation cross-linking and silane cross-linking.

As shown in FIG. 1, the mixing tank for dissolving plastics mixes introduced plastics and solvents.

The solvents introduced into the tank may be selected from a solvent appropriate to dissolve (at least partially) any one or more of the plastics in the mixing tank. In some embodiments one or more of the plastic source may be in a dissolved state when introduced into the mixing tank. In this case, the solvent in the mixing tank must be sufficient to ensure that the dissolved plastic remains in a substantially dissolved state.

The solvent(s) to dissolve the dissolvable plastic may be selected from an organohalide solvent, an aromatic hydrocarbon solvent, a mineral spirit, a dearomatised hydrocarbon solvent or a combination thereof.

An organohalide solvent is one that has a halide substituent. For example, the halide group may be selected from a fluoride or chloride. The organohalide solvent may be a haloalkane. The organohalide solvent may be a C₁, C₂, C₃, C₄, C₅, C₆, C₇, C₈, C₉ or C₁₀ hydrocarbon. The organohalide solvent may be an organochloride solvent. An organochloride solvent is a compound that contains at least one covalently bonded atom of chlorine, such as methyl chloride (one Cl atom) or methylene chloride (two Cl atoms). Examples of a suitable organochloride solvent is methyl chloride, methylene chloride or trichloroethylene, or a combination thereof.

An aromatic hydrocarbon solvent is one that has an aromatic substituent group. In one embodiment the aromatic group is a benzene ring. Preferably the aromatic group has one or more functional groups. The functional groups may be selected from one or more of a methyl or ethyl group. The aromatic hydrocarbon solvent may be selected from toluene or xylene, or a combination thereof. Toluene is an aromatic hydrocarbon and commonly used as a solvent for paint and paint thinners.

A mineral spirit (also referred to as white spirit, petroleum spirit or turpentine) is a mixture of aliphatic, open-chain or alicyclic C₇ to C₁₂ hydrocarbons.

Dearomatised solvents are highly hydrogenated solvents that have a low aromatic content and are generally classed as aliphatic mineral spirits. The dearomatised solvent may be selected from the Exxsol™ range of solvents provided by ExxonMobil Chemical. For example, the dearomatised solvent may be selected from Exxsol™ D40, Exxsol™ D60, Exxsol™ D80 or Exxsol™ D100, or a combination thereof. The dearomatised solvent may be selected from the ShellSol range such as ShellSol D60 which consists predominantly of C₁₀-C₁₂ paraffins and naphthenes.

In one embodiment the solvent comprises trichloroethylene. We have found that trichloroethylene is efficient at breaking down ABS plastics and styrene.

In one embodiment the solvent comprises methylene chloride. We have found that methylene chloride is efficient at breaking down ABS plastics and styrene.

As discussed above, it is important to match the solvent being used to the plastic source. For example, a dearomatised solvent or xylene (alone) may not be effective where the plastic is ABS. Preferably, where the plastic is ABS the solvent is selected from an organohalide solvent such as trichloroethylene or methylene chloride.

In one embodiment a combination of solvents is used.

For example, the combination of solvents may comprise a solvent and a co-solvent. As an example of this, a solvent (acting as a co-solvent) such as an organohalide solvent (e.g. trichloroethylene or methylene chloride) may be used in a smaller amount or concentration relative to it being used as a solvent. A second solvent, such as a dearomatised solvent may then be used to continue the breakdown of the plastic. In this manner, it may be possible to reduce the amount of less environmentally friendly solvents used in the process.

A mineral spirit may be added as a solvent or co-solvent to the mixture. In one embodiment we have found that the mineral spirit reduces the drying time of the binder.

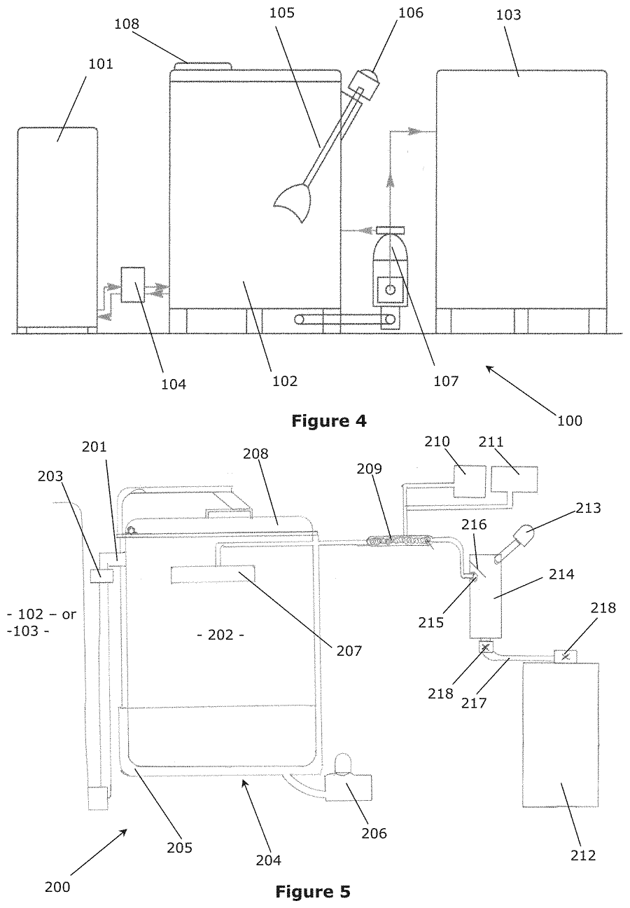

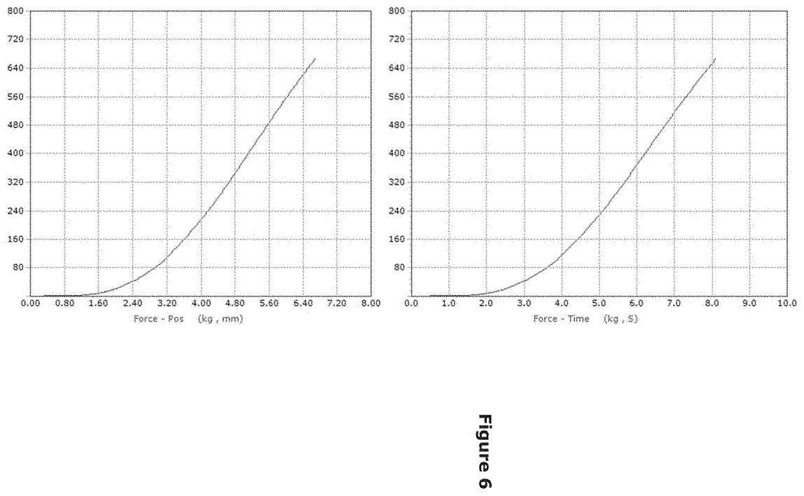

The mixing tank 102 as shown in FIG. 4 receives a plastic source as described above in Section 1 and a solvent as described in Section 2. The mixing tank is typically in the form of a vessel or tank that includes a stirrer 105 having at least one blade on its end.

A mixing tank 102 is shown in FIG. 4. The mixing tank 102 comprises an access hatch 108 through which material may be introduced into the mixing tank. Alternately, the mixing tank may include an inlet through which a plastic slurry is introduced into the mixing tank 102.

The design 100 may also include a solvent storage tank 101 that is fluidly connected to the mixing tank 102. This may include an include pump 104 that pumps the solvent from the solvent storage tank 101 to the mixing tank 102.

The mixing tank 102 includes a system inlet through which the solvent is introduced and one or more outlets.

The mixing tank 102 may comprises a vessel comprising a stirrer 105. The stirrer 105 may be configured to agitate the system inlet slurry within the mixing tank 102 to produce agitated slurry. Preferably the stirrer 105 creates a vortex within the vessel. Without wishing to be restrained by theory, the vortex assists in keeping the waste plastic particles suspended in the vessel, to prevent the waste plastic from settling at the bottom of the vessel.

Alternatively, where the density of the waste plastic is less than the density of the carrier liquid, the plastic may at least partially float within the vessel. In such a configuration, the stirrer may preferably create a vortex or flow within the vessel to draw the plastic from floating in the vessel downwards to an outlet of the vessel, for example to a homogenizer 107.

The stirrer 105 preferably creates a homogeneous mix of plastic and solvent such as water within the vessel.

The stirrer 105 of the agitator preferably operates at a rotational rate that achieves substantial homogeneity of the material within the slurry. By “substantial”, this means at least 70, 75, 80, 85, 90 or 95% homogeneity. Without wishing to be bound by theory, this degree of homogeneity is sufficient to achieve the desired input feed rate of the material to the macerator 10, without the macerator jamming. For example, the stirrer may be operated by a motor 106 at speeds of approximately 100 RPM to approximately 5,000 RPM.

In some forms, the stirrer 105 may increase in operational speed over the processing of a fixed quantity of plastic from the vessel. For example, if the mass or volume of plastic relative to the volume of solvent in the vessel decreases over the operation of the process, the operational speed of the of the stirrer may be increased in order to maintain a constant, or substantially constant, flow rate of plastic from the outlet of the vessel and to the macerator 10. For example, the stirrer may begin at approximately 2,000 RPM, and be increased to approximately 5,000 RPM by the end of processing of a fixed quantity of plastic from the agitator.

In addition or alternative, in some forms the operational speed of the stirrer may be controlled dependent on the size, or average size, of the plastic particles within the vessel.

In some embodiments the mixing tank 102 comprises one or more baffles the one of more baffles extending from an inner wall of the vessel of the mixing tank 102. Without wishing to be bound by theory, the baffles may act to retain the plastic particles to the centre of the vessel.

The stirrer 105 may act to further reduce the particle size of the plastic.

In some embodiments a plate is located above the stirrer. The plate has a diameter about equal to the diameter of the stirrer blades. Preferably the diameter of the blade is 80, 95, 90, 95, 100, 105, 110, 115 or 120% the diameter of the stirrer blade, and suitable ranges may be selected from between any of these values.

In some embodiments the waste plastic from the outlet of the agitation stage has a particle size of 0.5, 1.0, 1.5, 2.0, 2.5, 3.0, 3.5 or 4.0 mm, and suitable ranges may be selected from between any of these values, (for example, about 0.5 to about 4.0, about 0.5 to about 3.0, about 0.5 to about 2.5, about 0.5 to about 1.5, about 1.0 to about 4.0, about 1.0 to about 3.5, about 1.0 to about 2.5, about 1.5 to about 4.0, about 1.5 to about 3.5, about 1.5 to about 2.5, about 2.0 to about 4.0, about 2.0 to about 3.5, about 2.0 to about 3.0, about 2.5 to about 4.0, about 2.5 to about 3.5, about 2.5 to about 3.0, or about 3.0 to about 4.0 mm).

The plastic may enter the inlet of the mixing tank 102 as a slurry as described. The liquid, that forms the slurry with the plastic particles, can be water or a solvent or a combination thereof.

Suitable solvents have been discussed above.

In some embodiments the stirrer 105 is operated for at least 1, 2, 3, 4, 5, 6, 7, 8, 9, 10 min, and suitable ranges may be selected from between any of these values.

In some embodiments the stirrer 105 is run as a continuous process, with the slurry exiting the outlet of the agitator with plastic particles that have reached a particle size of less than 0.5, 1.0, 1.5, 2.0, 2.5, 3.0, 3.5 or 4.0 mm, and suitable ranges may be selected from between any of these values, (for example, about 0.5 to about 4.0, about 0.5 to about 3.0, about 0.5 to about 2.5, about 0.5 to about 1.5, about 1.0 to about 4.0, about 1.0 to about 3.5, about 1.0 to about 2.5, about 1.5 to about 4.0, about 1.5 to about 3.5, about 1.5 to about 2.5, about 2.0 to about 4.0, about 2.0 to about 3.5, about 2.0 to about 3.0, about 2.5 to about 4.0, about 2.5 to about 3.5, about 2.5 to about 3.0, or about 3.0 to about 4.0 mm).

This particle size selection can be achieved through the use of a particle size selector on the outlet pipe, such as a mesh having a mesh size that allows plastic particles below a desired size through. The stirrer 105 acts to prevent build-up of larger-sized plastic particles about the size selector at the outlet.

The plastic slurry in the mixing tank 102 may be pumped to a homogenizer 107 via a homogenizer inlet, and the homogenised slurry returned to the mixing tank 102 via a homogenizer outlet, or sent to a storage tank 103. An example of a homogenizer to achieve the above is the use of a macerator having two or more cylindrical bodies that rotate relative to each other. This is described fully in Section 4 below.

The homogenizer may reduce the particle size of the plastic particles, and also ensures a more homogenous particle size distribution.

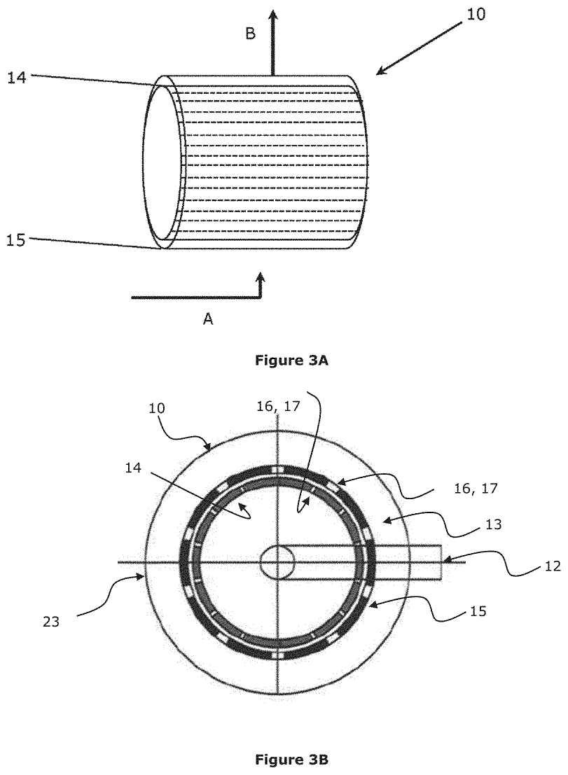

The process includes the use of one or more homogenizers 10, for example as shown in FIGS. 3A and 3B. The homogenizer 10 may form part of the system or method as described herein. The homogenizer 10 comprises an inlet 11. The inlet 11 receives a flow of inlet slurry comprising plastic particles from the mixing tank. The homogenizer 10 also comprises an outlet 12. The outlet 12 provides the processed slurry from the homogenizer 10 to the mixing tank.

The homogenizer 10 may comprise one or more pairs of cylindrical bodies 13. The pair of cylindrical bodies 13 may comprise an inner cylindrical body 14 and an outer cylindrical body 15. The inner cylindrical body 14 and the outer cylindrical body 15 may rotate relative to each other.

The inner cylindrical body 14 and the outer cylindrical body 15 rotate relative to each other at a rotational speed of about 100, 150, 200, 250, 300, 350, 400, 450, 500, 550, 600, 650, 700, 750, 800, 850, 900, 950 or 1,000 RPM, and suitable ranges may be selected from between any of these values, (for example, about 100 to about 1000, about 100 to about 900, about 100 to about 700, about 100 to about 600, about 100 to about 500, about 200 to about 1000, about 200 to about 800, about 200 to about 700, about 200 to about 600, about 200 to about 500, about 200 to about 400, about 300 to about 1000, about 300 to about 900, about 300 to about 700, about 300 to about 600, about 300 to about 500, about 300 to about 400, about 400 to about 1000, about 400 to about 700, about 400 to about 600, about 400 to about 500, about 500 to about 1000, about 500 to about 900, about 500 to about 700, about 500 to about 600, about 600 to about 1000, or about 600 to about 700 RPM).

More preferably, the inner cylindrical body 14 and the outer cylindrical body 15 rotate relative to each other at a rotational speed of about 500, 520, 540, 560, 580, 600, 620, 640, 660, 680 or 700 RPM, and suitable ranges may be selected from between any of these values, (for example, about 500 to about 700, about 500 to about 660, about 500 to about 600, about 520 to about 700, about 520 to about 640, about 540 to about 700, about 540 to about 660, about 540 to about 600, about 560 to about 700, about 560 to about 660, about 560 to about 620, about 580 to about 700, about 580 to about 660, about 580 to about 620, about 600 to about 700, about 600 to about 680, about 600 to about 640, about 620 to about 700, about 620 to about 680, about 640 to about 700 RPM).

The speed of relative rotation of the inner cylindrical body 14 and outer cylindrical body 15 may be provided dependent on one or more other variables, such as for example the feed rate of plastic and carrier solvent to the homogenizer 10, the proportion of plastic to carrier solvent in the inlet feed, the type of carrier solvent, the maximum particle size of inlet plastic, the average particle size of inlet plastic, the dimensions of the homogenizer 10 relative to a) the inlet particle size, b) the inlet plastic and/or carrier flow rate, c) the dimensions of the inlet conduit to the homogenizer, and/or d) the type or types of inlet plastic. It may also be dependent on, either separately or in addition, the dimensions or other characteristics of the agitator, the fill level of the agitator, the relative proportions of plastic and solvent in the agitator, and the agitator RPM rate.

The slot or apertures in the cylindrical bodies provide elongate sections of the cylindrical bodies adjacent the slot or aperture having a leading and trailing edge.

In one embodiment the leading edge and trailing edge of the elongate sections of the cylindrical body are positioned parallel to the notional circumference of the rotational axis of the cylindrical body.

In an alternate embodiment the leading edge of the elongate sections of the cylindrical body are positioned at an angle to the notional circumference of the rotational axis of the cylindrical body. Preferably the leading edge is positioned at an angle of about 5, 10, 15, 20, 25 or 30 degrees relative to the notional circumference of the rotational axis of the cylindrical body, and suitable ranges may be selected from between any of these values, (for example, about 5 to about 30, about 5 to about 25, about 5 to about 20, about 5 to about 15, about 10 to about 40, about 10 to about 20, about 10 to about 15, about 15 to about 30, about 15 to about 25 or about 20 to about 30 degrees).

Each cylindrical body (inner cylindrical body 14 and the outer cylindrical body 15) may have at least one or a plurality of apertures 16. The apertures 16 may extend through the respective body. The apertures 16 may define a flow path through each cylindrical body.

The inlet slurry may traverse the flow path from the homogenizer inlet 17 to the homogenizer outlet 18 via the at least one aperture 16 of each cylindrical body to produce an outlet slurry.

In some embodiments, the homogenizer 10 may comprise one or more inlets 17. The homogenizer inlets 17 may be spaced equidistantly about the homogenizer housing.

The inlet slurry may be provided at pressure to the inlet of the homogenizer. In some embodiments the rotation of the cylindrical bodies is configured to draw in said inlet slurry.

The inner and outer cylindrical bodies of the homogenizer are separated from each other by about 20, 30, 40, 50, 60, 80, 90, 100, 110, 120, 130, 140, 150, 160, 170, 180, 190, 200 μm, and suitable ranges may be selected from between any of these values, (for example, about 20 to about 200, about 30 to about 200, about 40 to about 200, about 50 to about 200, about 60 to about 200, about 70 to about 200, about 80 to about 200, about 90 to about 200, about 100 to about 200, about 110 to about 200, about 120 to about 200, about 130 to about 200, about 140 to about 200, about 150 to about 200, about 160 to about 200, about 170 to about 200, about 180 to about 200, about 190 to about 200, about 20 to about 30, about 20 to about 40, about 20 to about 50, about or 20 to about 60 μm).

In an alternate embodiment the inner and outer cylindrical bodies of the homogenizer are separated from each other by less than about 60, 55, 40, 35, 30, 25, or 20 μm, and suitable ranges may be selected from between any of these values, (for example, about 20 to about 25, about 20 to about 30, about 20 to about 35, about 20 to about 40, about 20 to about 55, about 20 to about 60, about 20 to about 25, about 30 to about 40, about 30 to about 55, about 30 to about 60, about 40 to about 55, or about 40 to about 60).

The rotation of the inner cylindrical body relative to the outer cylindrical body applies a shear stress to the plastic particles as they pass through the apertures 16 of the outer cylindrical body 15 through the intermediate space between the outer cylindrical body 15 and the inner cylindrical body 14 and through the apertures 16 of the inner cylindrical body 14, to the outlet.

FIGS. 3A and 3B show apertures 16 in the inner cylindrical body 14 however apertures 16 are not shown in the outer cylindrical bodies for simplicity.

In some embodiments, the apertures 16 of the inner cylindrical body 14 may be approximately half the size of the apertures 16 of the outer cylindrical body 15, or the apertures 16 of the outer cylindrical body 15 are approximately twice the size of the apertures 16 of the inner cylindrical body 14.

In some embodiments, the outlet 12 of the homogenizer is provided internal to the inner cylindrical body 14, and the inlet 11 is provided external to the outer cylindrical body 15.

The homogenizer 10 may comprise a housing to house the pairs of cylindrical bodies 13. In some embodiments, a motor may be coupled or connected to said housing so as to rotate the inner cylindrical body 14 relative to the outer cylindrical body 15.

The outlet slurry from the homogenizer 10 may have a plastic particle size being less than a predetermined plastic particle size. In some embodiments, the predetermined particle size is less than about 20, 19, 18, 17, 16, 15, 14, 13, 12, 11, 10, 9, 8, 7, 6, 5, 4, 3, 2, 1, or 0.5 μm, and suitable ranges may be selected from between any of these values.

The apertures 16 may be or comprise one or more slots 17. The slots 17 may be located vertically, and/or in a direction from the top of the cylindrical body to the bottom of the cylindrical body. The slots 17 may be oriented in a direction along or parallel with an axis of rotation or the cylindrical body. In some embodiments, the slots 17 may be oriented in a direction with respect to a length of the cylindrical body.

In some embodiments, the slots 17 may be angled with respect to a vertical or axial axis, or an axis of rotation of the cylindrical body, or an axis parallel to a vertical or axial axis, or an axis of rotation of the cylindrical body. In some embodiments, the slots 17 may be angled with respect to a length of the cylindrical body.

In some embodiments, the slots of the outer cylindrical body are wider than the slots of the inner cylindrical body. For example, the slots of the outer cylindrical body may be about 1.5 to about 2.5 times wider than the slots of the inner cylindrical body. As a further example, the slots of the outer cylindrical body may be about 2 times wider than the slots of the inner cylindrical body.

In some embodiments, at least one slot of the outer cylindrical body comprises a projection from the outer surface of the outer cylindrical body. This projection may comprise a blade.

The projection from the outer surface of the outer cylindrical body preferably extends in the direction of rotation of the outer cylindrical body at an acute angle relative to the outer surface of the outer cylindrical body. For example, the projection may extend at an angle of about 5, 10, 15, 20, 25 or 30 degrees. As a further example, the projection may extend at an angle of about 15 degrees.

In some embodiments a width of the one or more slots 17 is substantially constant along a length of the slot 17. In some embodiments the width of the slots 17 varies along a length of the slot 17.

The slots 17 may vary in width from an outer surface of the cylindrical body to an inner surface of the cylindrical body. The slots 17 may taper in width from an outer surface of the cylindrical body to an inner surface of the cylindrical body, or from an inner surface of the cylindrical body to an outer surface of the cylindrical body.

The slot at an outer surface may be greater than a width of the slot at an inner surface. The width of the slot at an inner surface is greater than a width of the slot at an outer surface.

The width of the one or more slots 17 are 1, 2, 3, 4, 5, 6, 7, 8, 9, 10, 11, 12, 13, 14 or 15 mm, and suitable ranges may be selected from between any of these values (for example, 1 to about 15, about 1 to about 12, about 1 to about 10, about 1 to about 8, about 2 to about 15, about 2 to about 13, about 2 to about 11, about 2 to about 9, about 2 to about 7, about 3 to about 15, about 3 to about 14, about 3 to about 10, about 3 to about 8, about 4 to about 15, about 4 to about 13, about 4 to about 11, about 4 to about 10, about 407, about 5 to about 15, about 5 to about 14, about 5 to about 12, about 5 to about 10, about 5 to about 8, about 6 to about 15, about 6 to about 13, about 6 to about 12, about 6 to about 8, about 7 to about 15, about 7 to about 14, about 7 to about 11, about 7 to about 9, about 8 to about 15, about 8 to about 14, about 8 to about 11, about 9 to about 15, about 9 to about 13, about 9 to about 11, about 10 to about 15, about 10 to about 13, about 11 to about 15, about 11 to about 14 or about 12 to about 15 mm).

The width of the one or more slots 17 may be between about 1 and about 15 mm, or about 1 mm, or about 3 mm, or about 4 mm, or about 5 mm, or about 6 mm, or about 7 mm, or about 8 mm, or about 9 mm, or about 10 mm, or about 11 mm or about 12 mm, or about 13 mm, or about 14 mm, or about 15 mm, or about 16 mm, or about 17 mm, or about 18 mm, or about 19 mm, or about 20 mm.

The inner cylindrical body 14 may be rotatable about an axial axis, and the outer cylindrical body 15 may be stationary.

Alternatively, the outer cylindrical body 15 may be rotatable about an axial axis, and the inner cylindrical body 14 is stationary.

In some embodiments the inlet body configured to provide for an inlet flow path for the pair of cylindrical bodies, may be stationary, and the outlet body configured to provide for an outlet flow path for the pair of cylindrical bodies may be rotating.

One or more of the inner cylindrical body 14 and the outer cylindrical body 15 are rotatable about an axial axis.

The homogenizer 10 may comprise an inner cylindrical body shaft 20. The inner cylindrical body shaft 20 may be coupled to the inner cylindrical body 14 and/or one or more inner cylindrical bodies to allow for rotation of the inner cylindrical body 14 and/or one or more inner cylindrical bodies relative to an axial axis of the inner cylindrical body and/or one or more inner cylindrical bodies. In some embodiments, the inner cylindrical body shaft 20 is provided with a pair of high speed water cooled bearings to allow for rotation of the inner cylindrical body shaft 20.

The homogenizer 10 may comprise an outer cylindrical body shaft 21. The outer cylindrical body shaft 21 may be configured to be coupled to the outer cylindrical body 21 and/or one or more outer cylindrical body to allow for rotation of the outer cylindrical body 15 and/or one or more outer cylindrical body relative to an axial axis of the outer cylindrical body 15 and/or one or more outer cylindrical body. In some embodiments, the outer cylindrical body shaft 21 is provided with a pair of high speed water cooled bearings to allow for rotation of the inner cylindrical body shaft 20.

The inner cylindrical body shaft 20 and/or the outer cylindrical body shaft 21 may be coupled to at least one motor 22. The at least one motor 22 may be configured to rotate the inner cylindrical body shaft 20 and/or the outer cylindrical body shaft 21.

The homogenizer 10 may include a liquid cooled bearing (not shown) on the cylindrical body shaft. The advantage of this design is that the slurry liquid is used to cool the bearing, which would otherwise operate at high temperatures due to the heat produced by the maceration of the plastic.

The inner cylindrical body 14 or the outer cylindrical body 15 may be an inlet body configured to provide for an inlet flow path for the pair of cylindrical bodies. The other of the inner cylindrical body 14 or the outer cylindrical body 15 may be an outlet body configured to provide for an outlet flow path for the pair of cylindrical bodies.

A width or other dimension, or largest dimension of the at least one aperture 16 of the inlet body 14 may be greater than a width or other dimension, or largest dimension of the at least one aperture 16 of the outlet body 15.

The homogenizer 10 may comprise a plurality of pairs of cylindrical bodies. Each pair of cylindrical bodies may be located concentrically with respect to each other pair of cylindrical bodies.

The homogenizer 10 may comprise at least a first pair of cylindrical bodies, and a second pair or cylindrical bodies. In some embodiments the homogenizer 10 may comprise a third pair or cylindrical bodies. In some embodiments the homogenizer 10 may comprise one or more further pairs of cylindrical bodies.

The flow path from an inlet of the homogenizer 10 to the outlet of the homogenizer 10 may be through the first pair of cylindrical bodies, followed by the second pair or cylindrical bodies, and optionally through the third pair of cylindrical bodies, and optionally through said one or more further pairs of cylindrical bodies.

The progression of the slurry through each pair of cylindrical bodies is configured to progressively decrease a particle size of plastic in the slurry. The number of pairs of cylindrical bodies, the size of the apertures in the each cylindrical body, and the distance between the pair of cylindrical bodies may be customized based on the characteristics of the inlet slurry, and the desired characteristics of the outlet slurry. In some embodiments, the surface area of the cylindrical bodies may be based on the desired flow rate of inlet slurry and/or the desired outlet particle size.

The first pair of cylindrical bodies 18 may comprises an inlet body (being one of the inner cylindrical body or the outer cylindrical body), and a width or other dimension, or largest dimension of the apertures of the inlet body is about 20 mm.

The first pair of cylindrical bodies 18 may comprises an outlet body (being the other of the inner cylindrical body and the outer cylindrical body), and a width or other dimension, or largest dimension of the apertures of the outlet body is about 17 mm.

The second pair of cylindrical bodies 19 may comprise an inlet body (being one of the inner cylindrical body or the outer cylindrical body) wherein a width or other dimension, or largest dimension of the apertures of the inlet body is about 17 mm.

The second pair of cylindrical bodies 19 may comprise an outlet body (being the other of the inner cylindrical body and the outer cylindrical body) wherein a width or other dimension, or largest dimension of the apertures of the outlet body is about 12 mm.

The third pair of cylindrical bodies may comprise an inlet body (being one of the inner cylindrical body or the outer cylindrical body) wherein a width or other dimension, or largest dimension of the apertures of the inlet body is about 12 mm.

The third pair of cylindrical bodies may comprise an outlet body (being the other of the inner cylindrical body and the outer cylindrical body) wherein a width or other dimension, or largest dimension of the apertures of the outlet body is about 3 mm.

The flow path from the homogenizer inlet to the homogenizer outlet may be provided through the apertures of each cylindrical body of each pair of cylindrical bodies.

The flow path from the homogenizer inlet to the homogenizer outlet may be provided from an innermost body to an outermost body via each intermediate body.

The flow path from the homogenizer inlet to the homogenizer outlet may be provided from an outermost body to an innermost body via each intermediate body.

The flow of inlet slurry may be provided to internal surface of the inner cylindrical body 14 and/or an internal surface of the inner cylindrical body 14 of the innermost pair of cylindrical bodies. For example where the inner cylindrical body 14 of the innermost pair of cylindrical bodies acts as an inlet body.

The flow of inlet slurry may be provided to external surface of the outer cylindrical body 15 and/or an external surface of the outer cylindrical body 15 of the outermost pair of cylindrical bodies. For example where the outer cylindrical body 15 of the outermost pair of cylindrical bodies acts as an inlet body.

In some embodiments the inlet body is stationary, and the outlet body rotates relative to the inlet body.

The inlet slurry may comprises plastic particles having a particle size of 4 mm to 20 mm, and optionally around 8 mm.

The outlet slurry may comprise plastic particles having a particle size of 0.5 μm to 20 μm.

The outlet slurry (after passing through the homogenizer 10) may comprise plastic particles having a plastic particle size. The plastic particle size is less than a predetermined plastic particle size.

In some embodiments, the predetermined plastic particle size is less than 0.5, 1, 2, 3, 4, 5, 6, 7, 8, 9, 10, 11, 12, 13, 14, 15, 16, 17, 18, 19 or 20 μm.

In some embodiments, if the plastic particle size is greater than the predetermined plastic particle size the outlet slurry may be directed to the homogenizer inlet 11 (for example cycled through the homogenizer 10 again), and/or to another homogenizer inlet 11 (for example to a further homogenizer inlet 11 of another homogenizer 10) until the outlet slurry has a particle size being less than the predetermined particle size.

In some embodiments the flow rate of inlet slurry provided to the homogenizer 10 may be based on one or more of: the plastic type and its particular characteristics for example the plastic melting point, the size of the apertures in the cylindrical bodies, the overall surface are of the cylindrical bodies, or the ratio of liquid to plastic in the slurry.

Also disclosed is a system 50 for processing plastic. The system may comprise an inlet configured to receive a system inlet slurry comprising plastic particles, and an outlet configured to deliver a system outlet slurry. The system may also comprise a maceration stage 51. The maceration stage 50 decreases the particle size of the plastic particles within the slurry, as the slurry passes through the maceration stage 51. The maceration stage 51 may comprise one or more homogenizer 10, as described above. The system inlet slurry may be provided to the maceration stage 51 so as to produce the system outlet slurry.

The system may comprise a plurality of homogenizers. At least two of the plurality of homogenizers may be arranged in series. Alternatively or additionally, at least two of the plurality of homogenizers may be arranged in parallel.

The outlet slurry of one of the one or more homogenizers 10 may be configured to be directed to the inlet of another of the one or more homogenizers, and/or to the inlet of the same homogenizer 10.

The system 50 may comprise at least a first homogenizer 52, and a second homogenizer 53, optionally the system comprises a third homogenizer 54, and optionally one or more further homogenizers 55.

One or more filter elements may be located between the output of one homogenizer and the input of another homogenizer. The one or more filter elements may filter out or prevent the passing of particles above a certain particle size. The one or more filter elements may be configured to ensure particles which are too large for the subsequent homogenizer (for example particles which might cause the homogenizer to become clogged) are not provided to the subsequent or next homogenizer.

A flow path may be provided from the inlet of the system to the outlet of the system via the first homogenizer 52, followed by the second homogenizer 53, and optionally followed by the third homogenizer 54, and optionally followed by one or more further homogenizers 55.

The first homogenizer 52 may comprise an inlet body (being one of the inner cylindrical body 14 or the outer cylindrical body 15). A width or other dimension, or largest dimension of the apertures 16 of the inlet body is about 20 mm, and an outlet body (being the other of the inner cylindrical body and the outer cylindrical body) wherein a width or other dimension, or largest dimension of the apertures of the outlet body is about 17 mm.

The second homogenizer 53 may comprise an inlet body (being one of the inner cylindrical body or the outer cylindrical body). A width or other dimension, or largest dimension of the apertures of the inlet body is about 17 mm, and an outlet body (being the other of the inner cylindrical body and the outer cylindrical body) wherein a width or other dimension, or largest dimension of the apertures of the outlet body is about 12 mm.

The third homogenizer 54 may comprise an inlet body (being one of the inner cylindrical body or the outer cylindrical body). A width or other dimension, or largest dimension of the apertures of the inlet body is about 12 mm, and an outlet body (being the other of the inner cylindrical body and the outer cylindrical body) wherein a width or other dimension, or largest dimension of the apertures of the outlet body is about 3 mm.

The system outlet slurry may comprise plastic particles having a plastic particle size. In some embodiments the plastic particle size is less than a predetermined plastic particle size.

The predetermined plastic particle size may be less than 0.5, 1, 2, 3, 4, 5, 6, 7, 8, 9, 10, 11, 12, 13, 14, 15, 16, 17, 18, 19 or 20 μm, and suitable ranges may be selected from between any of these values.

In some embodiments, if the plastic particle size is greater than the predetermined plastic particle size the outlet slurry of one of the plurality of homogenizers is directed to the homogenizer inlet (for example being cycled back into the same homogenizer), and/or to another homogenizer inlet (for example of another homogenizer 10 of the plurality of homogenizers) until the outlet slurry has a particle size of less than the predetermined particle size.

The inlet slurry may be recycled through the maceration stage 51 until the outlet slurry has a particle size of less than the predetermined particle size.

The time to pass through the homogenizer may be controlled by modifying the speed of relative rotation between the inner cylindrical body and the outer cylindrical body, and/or the spacing between the inner cylindrical body and the outer cylindrical body, and/or the flow rate of the slurry, and/or the particle sizes of the particles in the slurry.

In some embodiments, the flow rate of the solvent through the homogenizer 10 may be about 10 liters per minute to about 1000 liters per minute. In particular, the flow rate of the solvent through the homogenizer 10 may be approximately 100 liters per minute.

In some embodiments, the ratio of carrier solvent such as water to plastic provided to the homogenizer is at a ratio of approximately 1 liter to 0.2 kg, to approximately 1 liter to 1.5 kg.

In some embodiments, the ratio of carrier solvent such as water to plastic provided to the homogenizer is at a ratio of approximately 1 liter to 1 kg.

As shown in FIG. 1, in some embodiments the system includes a solvent recovery process. The solvent recovery process extracts solvent from the plastic slurry and may feed that solvent back to the mixing tank. This helps to reduce the amount of solvent lost from the system, making the process more economical and environmentally friendly.

As shown in FIG. 4 is an example of a solvent recovery system 200. The solvent recovery system includes an inlet 201 that receives solvent from the mixing tank 102 or storage tank 103 of FIG. 3.

In some embodiments the solvent recovery system 200 include one or more valves 203 to control the entry of solvent into the heating chamber 202. The heating chamber 202 may include a sealed lid 208. In one embodiment the valve 203 is an air operated valve. The heating chamber 202 comprises a heating arrangement 204 which may be a jacket heater or coil heater. The heating may be provided by circulated hot oil, hot water or gas heating 205. In those embodiments in which heating is provide for by oil or water heating 205, the solvent recovery system 200 may include a circulating pump 206 to circulate the heated working fluid. The heating chamber 202 may also include a thermostat to control the temperature of the slurry, which will control the rate at which the solvent is vaporised.

The solvent recovery system 200 may also include a suction head 207 that receives evaporated solvent. The evaporated solvent then passes from the suction head 207 to a chiller 209. Preferably the chiller is a coiled chiller and includes a chilled water unit 210 or refrigeration unit 211.

In some embodiments the solvent recovery system 200 provides a vacuum to assist movement of the solvent from the suction head 207 via the chiller unit 209 to a receiving tank 212. Thus, the solvent recovery system 200 may include a vacuum fan 213 within a tube 214. The tube may include an inlet 215 having a steel tongue 216 placed above the inlet 215. The solvent recovery system 200 may also include one or more valves 218 prior to the receiving tank 212 to control entry of the solvent into the tank 212.

The solvent recovery system 200 may include a pipe 217 to the receiving tank 212 having an angle that allows of the vapours to condense into a liquid. The liquid then runs down the pipe 217 and into the receiving tank 212.

The material entering the solvent recovery system 200 may comprise a mixture of dissolved plastic, water and organic solvent.

In some embodiments the solvent recovery system 200 removes at least 70, 75, 80, 85, 90, 95 or 98% of the organic solvent, and suitable ranges may be selected from between any of these values, (for example, about 70 to about 98, about 70 to about 95, about 70 to about 85, about 75 to about 98, about 75 to about 95, about 75 to about 85, about 80 to about 98, about 80 to about 95, about 80 to about 90, about 85 to about 95, about 85 to about 90, about 90 to about 98, about 90 to about 95%).

The resultant emulsion is a plastic in water emulsion and can be utilised in a number of different products, such as cold or hot roading, concrete, or water-based products.

In some embodiments an emulsifier (e.g. an anionic or nonionic ethoxylated fatty acid) is added to prevent separation of the plastic from the solvent.

Binders for polymerisation may be formed from with monoethylenically unsaturated monomers, which may comprise a mixture of two or more monomer structural units in combination with a curing aid. Each unit may have a different homopolymer glass transition temperature (T_{g}), wherein a first monomer structural unit has a homopolymer T_{g} of greater than 80° C. and a second monomer having a homopolymer T_{g} of less than 80° C.

The second monomer may have a homopolymer T_{g} of less than 50° C.

The second monomer may have a homopolymer T_{g} of less than 25° C.

The glass transition temperature (T_{g}) values for the homopolymers of the majority of monomers are known and are listed for example in Ullmann's Encyclopedia of Industrial Chemistry, volume A21, page 169, 5th edition, VCH Weinheim, 1992. T_{g} values for statistical copolymers can then be calculated using the Fox equation, 1/T_{g}=w1/T_{g}, 1+w2/T_{g}, 2+ . . . +wn/T_{g},n, where w1, w2, . . . , wn are the weight fractions of monomers 1, 2, . . . , n, and Tg,1, T_{g}2, . . . , T_{g},n are the glass transition temperatures of their respective homopolymers (in Kelvin). Alternatively, the T_{g} values of the copolymers can be determined by differential scanning calorimetry (DSC) according to ISO 16805.

The first monomer is preferably a monomer that has a homopolymer T_{g} of greater than 80° C. which assists in providing hardness to the product that incorporates the binder. The first monomer may be based on ethylenically unsaturated monomer units. The ethylenically unsaturated monomer may comprise monoethylenically unsaturated monomer units and/or multiple unsaturated units, such as at least one vinyl group.

Monomer units comprising vinyl groups contain at least one C═C double bond which can be polymerized by known processes with further C═C double bonds or with further functional groups which can react with C═C double bonds, to give a polymer chain based at least partly on C—C recurring units. The polymer chain may comprise one or more side groups such as ionic, cationic or anionic functional groups. Such groups may be dissociable.

The monoethylenically unsaturated monomers may contain acid groups such as carboxylic acid groups, sulphonic acid or phosphonic acid. The monoethylenically unsaturated monomers may contain nitrogen groups like acrylamide, acrylonitrile and N-methylol acrylamide.

Ethylenically unsaturated carboxylic acid monomers may be selected from acrylic acid, methacrylic acid, ethacrylic acid, acyanoacrylic acid, β-methacrylic acid (crotonic acid), a-phenylacrylic acid, β-acryloxypropionic acid, sorbic acid, 2′-methylisocrotonic acid, cinnamic acid, β-stearylic acid, itaconic acid, citraconic acid, mesaconic acid, glutaconic acid, aconitic acid, maleic acid and fumaric acid.

Ethylenically unsaturated sulphonic acid monomers may be selected from allylsulphonic acid or aliphatic or aromatic vinylsulphonic acids or acrylic or methacrylic sulphonic acids. Aliphatic or aromatic vinylsulphonic acids may be selected from vinylsulphonic acid, 4-vinylbenzylsulphonic acid, vinyltoluenesulphonic acid and styrenesulphonic acid. Acryl- and methacrylsulphonic acids may be selected from sulphoethyl(meth)acrylic acid, sulphopropyl(methyl)acrylic acid, 2-hydroxy-3-methacryloxypropylsulphonic acid and (meth)acrylamidoalkylsulphonic acids, such as 2-acrylamido-2-methylpropanesulphonic acid.

Ethylenically unsaturated phosphonic acid monomers may be selected from vinylphosphonic acid, allylphosphonic acid, vinylbenzylphosphonic acid (meth)acrylamidoalkylphosphonic acids, acrylamidoalkyldiphosphonic acids, phosphonomethylated vinylamines and (meth)acrylphosphonic acid derivatives.

The monomer may be a derivatives of the abovementioned monomers containing acid groups. The monomer may be an ester derivatives, and in particular, ester derivatives that are obtainable by reaction of one of the abovementioned carboxylic acids with a linear or branched C₁-C₂₀ alcohol (preferably a linear or branched C₁-C₁₂ alcohol or a linear or branched C₁-C₈ alcohol or a linear or branched C₁-C₄ alcohol).

The monomer may comprise ester derivatives selected from methyl acrylate, ethyl acrylate, propyl acrylate, butyl acrylate, methyl methacrylate, ethyl methacrylate, propyl methacrylate or butyl methacrylate.

The monomer may comprise structural units of methyl methacrylate, butyl methacrylate, ethyl acrylate, butyl acrylate, or 2-ethylhexyl acrylate, or a combination thereof.

Any acrylic or methacrylic acid ester which, when polymerized, gives a homopolymer having a T_{g} value greater than 25° C., preferably greater than 50° C., can be used. Examples of suitable monomer esters include isobomyl acrylate, isobomyl methacrylate, methyl methacrylate, ethyl methacrylate, isopropyl methacrylate, isobutyl methacrylate, tert-butyl methacrylate, tert-butyl acrylate, n-propyl methacrylate, isobutyl methacrylate and cyclohexyl methacrylate.

The monomer may comprise from 20 to 80% by weight, more preferably from 25 to 75% by weight, most preferably from 30 to 70% by weight, of the monomer composition used to produce the copolymer dispersion described herein.

The second monomer may have a homopolymer T_{g} value of less than 80° C. and provides some degree of softening of the final product characteristics.

Any acrylic or methacrylic acid ester which, when polymerized, gives a homopolymer having a T_{g} value less than 25° C., preferably less than 0° C., can be used as the second monomer. Examples of suitable esters include methyl acrylate, ethyl acrylate, n-propyl acrylate, isopropyl acrylate, n-butyl methacrylate, n-butyl acrylate, isobutyl acrylate, 1-hexyl acrylate, 2-ethylhexyl acrylate, heptyl acrylate, n-octyl acrylate, 2-octyl acrylate, dodecyl methacrylate, dodecyl acrylate, tridecyl methacrylate, methacrylic ester 17.4, and mixtures thereof.

TABLE 1
Exemplified monomers and their glass transition temperature

| | Glass |
|---|---|
| | transition |
| Monomer | temp (° C.) |
| 2-EHA | −70 |
| Butyl Acrylate | −56 |
| Ethyl Acrylate | −22 |
| VEOVA 10 | −20 |
| 2-Hydroxy Ethyl Acrylate | −15 |
| Dibutyl Maleate | −10 |
| Hydroxy Propyl Acrylate | 6 |
| AAEM | 8 |
| Methyl Acrylate | 8 |
| DMAEMA | 18 |
| Butyl Methacrylate | 22 |
| Sipomer WAM | 30 |
| Vinyl Acetate | 30 |
| WAM IV | 30 |
| Allyl methacrylate | 52 |
| Hydroxy Ethyl Methacrylate | 55 |
| n-Methylolmethacrylamide | 59 |
| Isobutyl Methacrylate | 70 |
| GMA | 75 |
| Diacetone Acrylamide | 77 |
| Plex 6844-O | 90 |
| DMAPMA | 96 |
| Acrylonitrile | 97 |
| Itaconic Acid | 97 |
| Styrene | 100 |
| TMPTA | 100 |
| Methyl Methacrylate | 105 |
| Acrylic Acid | 106 |
| Acrylamide | 165 |
| Methacrylic Acid | 210 |
| Methacrylamide | 252 |
| n-Methylolacrylamide | 316 |

In one embodiment the acrylate monomer is an acrylate monomer selected from the acrylate monomers of Table 1.

The binder may also include a cross-linking moiety. The cross-linking moiety may comprise a bi- or tri-functional ester monomer such as trimethylolpropane triacrylate. The cross-linking agent assists to form the three-dimensional structure of the final product.

The binder may also include a cross-linker and a promotor.

The cross-linker may be a peroxide based cross-linker.

A cross linking agent is one that links one polymer chain to another. The links may be covalent or ionic bonds. Cross linking of thermoplastics is part of the curing process since when polymer chains are cross linked, the material becomes more rigid.

While cross linking can be initiated by heat, pressure, change in pH or irradiation, the cross linking agent as used herein refers to a chemical that results in a chemical reaction that forms cross links. That is not to exclude that cross linking may also occur due to the heat and pressure used in the current process.

In one configuration the cross linking agent may be a peroxide-based cross linker. In some configurations the peroxide can be selected from inorganic peroxides, diacyl peroxides, peroxyesters, peroxydicarbonates, dialkyl peroxides, ketone peroxides, peroxyketals, cyclic peroxides, peroxymonocarbonates, hydroperoxides, dicumyl peroxide, benzoyl peroxide, 2,5-Di(tert-butylperoxy)-2,5-dimethyl-3-hexyne, 3,3,5,7,7-pentamethyl 1,2,4-trioxepane, dilauryl peroxide, methyl ether ketone peroxide, t-amyl peroxyacetate, t-butyl hydroperoxide, t-amyl peroxybenzoate, D-t-amyl peroxide, 2,5-Dimethyl 2,5-Di(t-butylperoxy)hexane, t-butylperoxy isopropyl carbonate, succinic acid peroxide, cumene hydroperoxide, 2,4-pentanedione peroxide, t-butyl perbenzoate, diethyl ether peroxide, acetone peroxide, arachidonic acid 5-hydroperoxide, carbamide peroxide, tert-butyl hydroperoxide, t-butyl peroctoate, t-butyl cumyl peroxide, Di-sec-butyl-peroxydicarbonate, D-2-ethylhexylperoxydicarbonate, 1,1-Di(t-butylperoxy)cyclohexane, 1,1-Di(tert-butylperoxy)-3,3,5-trinnethylcyclohexane, 2,5-Dimethyl-2,5-di(tert-butylperoxy)hexane, 3,3,5,7,7-Pentamethyl-1,2,4-trioxepane, Butyl 4,4-di(tert-butylperoxy)valerate, Di(2,4-dichlorobenzoyl) peroxide, Di(4-methylbenzoyl) peroxide, Di(tert-butylperoxyisopropyl)benzene, tert-Butyl cumyl peroxide, tert-Butyl peroxy-3,5,5-trimethylhexanoate, tert-Butyl peroxybenzoate, tert-Butyl peroxy 2-ethylhexyl carbonate, and mixtures thereof.

In one configuration the cross linker maybe a silane cross-linking agent. The silane cross-linker may be selected from an acetoxy silane crosslinker, an oximino silane based crosslinker, a methylethylketoxime (MEKO) based crosslinker, a methylisobutylketoxime (MIBKO) based crosslinker, an acetoxime based crosslinker, an alkoxy silane based crosslinker, or a combination thereof. In some examples, the crosslinker includes a methyl tris(MEKO)silane, a tetra(MEKO)silane, a vinyl tris(MEKO)silane, a methylvinyl di(MEKO)silane, a phenyl tris(MEKO) silane, a methyl tris(MIBKO)silane, a tetra(MIBKO)silane, a vinyl tris(MIBKO)silane, a methyl tris(acetoxime)silane, a vinyl tris(acetoxime)silane, or a mixture thereof.

The binder may also include a promoter. The promoter may increase the speed of polymerisation. Without wishing to be bound by theory, the promoter may increases the amount of free radicals by the cross linking agent, which increases the rate of polymerisation of the thermoplastic material to theromoset material. The promoter may be selected from N,N-dimethyl-p-toludine or N,N-diethyl-p-toludine.

The binder as described may be used to manufacture a roading composition.

As discussed above, the binder may be formed from at least a mixture of plastics and solvent as shown in FIG. 2, or a combination of an acrylate monomer and a cross-linker as described above.

The binder may comprise a monomer as described in paragraphs [0323] to [0340].

The plastics source for use in the monomer binder may comprise a combination of plastics as described in paragraphs [0171] to [0199] above. The plastic source may comprise at least 30% by weight of the total plastic of a plastic that contains a styrene unit. In some configurations the plastic source comprises 30, 35, 40, 45, 50, 55 or 60% by weight of the total plastic of a plastic that originated from a styrene based monomer, and suitable ranges may be selected from between any of these values, (for example, about 30 to about 60, about 30 to about 50, about 30 to about 40, about 35 to about 60, about 35 to about 50, about 40 to about 60, about 40 to about 55, about 45 to about 60, about 50 to about 60% by weight of the total plastic of a plastic that originated from a styrene based monomer).

The solvent for dissolution of a plastic may be selected from an organohalide solvent, an aromatic hydrocarbon solvent, a mineral spirit, a dearomatised solvent or a combination thereof as discussed in paragraphs [0200] to [0212] above.

The solvent and plastic is mixed together in the mixing tank.

The source plastic may be in a number of forms. Such as:
a) chipped plastic,
b) plastic that has been processed to a particle size of less than 8 mm,
c) plastic (or a portion thereof) that has been dissolved in a solvent, or
d) any combination of (a) to (c).

The chipped plastic may be produced by any process that reduces the plastic to a particle size of between 8, 9, 10, 11, 12, 13, 14, 15, 16, 17, 18, 19 or 20 mm, and suitable ranges may be selected from between any of these values, (for example, about 8 to about 20, about 8 to about 16, about 8 to about 12, about 9 to about 20, about 9 to about 18, about 9 to about 16, about 9 to about 13, about 10 to about 20, about 10 to about 18, about 10 to about 16, about 10 to about 13, about 11 to about 20, about 11 to about 18, about 11 to about 14, about 12 to about 20, about 12 to about 16, about 13 to about 20, about 13 to about 19, about 13 to about 16, about 14 to about 20, about 14 to about 18, about 15 to about 20 mm). Various methods are known such as shredding, granulation and grinding.

In relation to shredding, the plastic is preferably first shredded to a particle size of less than 10 mm. Preferably the shredded plastic has a particle size of about 2, 3, 4, 5, 6, 7, 8, 9, or 10 mm, and suitable ranges may be selected from between any of these values, (for example, about 2 to about 10, about 2 to about 8, about 2 to about 6, about 2 to about 5, about 3 to about 10, about 3 to about 9, about 3 to about 8, about 3 to about 6, about 4 to about 10, about 4 to about 8, about 4 to about 6, about 5 to about 10, about 5 to about 9 or about 6 to about 10 mm).

Various methods are known to reduce the original plastic products to a particle size as described above in paragraphs [0181] to [0183].

A further source of plastic could include homogenised slurry of plastic having a particle size of less than 2 mm.

In relation to a plastic that has been processed to a particle size of less than 8 mm, such plastic may be processed by a homogenizer such as that described above from paragraph [0234]. For example, the homogenizer may comprise of a machine having a series of rotating cylinders.

The plastic (or a portion thereof) that has been dissolved in a solvent may be any plastic that is dissolvable in a solvent. For example, the plastic may be a homopolymer of a styrene based monomer or ethylene monomer. The plastic may comprise a copolymer of an alkene and vinyl acetate, acrylic polymer or be a nylon based polymers or co-polymers.

The dissolved (or portion thereof) may be dissolved (or at least partially dissolved) prior to addition into the mixing tank. In the case where the plastic is partially dissolved, the plastic may be completely dissolved in the mixing tank. The dissolvable plastic may be dissolved in the mixing tank.

Multiple types of plastics may be mixed in the mixing tank. For example, a combination of dissolvable plastics and chipped plastic, or a combination of dissolvable plastics and processed plastic, or a combination of chipped plastic and processed plastic.

In the case where the mixing tank includes the addition of chipped plastic, the mixing tank may be fluidly connected to a homogenizer that reduces the size of the chipped plastic to a smaller particle size. For example, the mixing tank may include an outlet to the inlet of a homogenizer such that the material in the mixing tank is fed to the homogenizer. The homogenizer(s) may then have an outlet that feeds to a storage tank, or back to the mixing tank. That is, the material in the mixing tank may be cycled between the homogenizer(s) and the mixing tank.

Any undissolved plastic in the mixing tank is preferably reduced in size to a particle size of less than 0.1, 0.5, 1.0, 1.5, 2.0, 2.5, 3.0, 3.5 or 4.0 mm, and suitable ranges may be selected from between any of these values, (for example, about 0.1 to about 4.0, about 0.1 to about 3.0, about 0.1 to about 1, about 0.1 to about 0.5, about 0.5 to about 4.0, about 0.5 to about 3.5, about 0.5 to about 2.0, about 1.0 to about 4.0, about 1.0 to about 3.0, about 1.5 to about 4.0, about 1.5 to about 3.0, about 2.0 to about 4.0, about 2.0 to about 3.5 or about 2.5 to about 4.0 mm).

In one embodiment substantially all of the plastic in the mixing tank is dissolved. As used herein, substantially means at least 80%, or at least 85%, or at least 90%, or at least 95%, or at least 99%.

The combination of plastic in the mixing tank provides a binder for use as a roading binder. The combination of plastics in the mixing tank comprises at least 30, 35, 40, 45, 50, 55 or 60% by weight of total plastic of a plastic that comprises a styrene based monomer, and suitable ranges may be selected from between any of these values, (for example, about 30 to about 60, or about 30 to about 45, or about 35 to about 60, or about 35 to about 55, or about 35 to about 40, or about 40 to about 60, or about 40 to about 55, or about 40 to about 50, or about 45 to about 60 or about 45 to about 55% by weight of the total plastic). An example of such a plastic may include polystyrene.

The plastic combination also comprises at least 40, 45, 50, 55, 60, 65 or 70% by weight of total plastic of a plastic that comprises a styrene copolymer, a copolymer of an alkene and vinyl acetate, acrylic polymer and nylon based polymers or co-polymers, and suitable ranges may be selected from between any of these values, (for example, about 40 to about 70, or about 40 to about 65, or about 40 to about 55, or about 45 to about 70, or about 45 to about 65, or about 45 to about 60, or about 50 to about 70, or about 50 to about 65, or about 55 to about 70, or about 55 to about 65, or about 55 to about 60 or about 60 to about 70% by weight of the total plastic).

The combination of plastics may comprise
a plastic that comprises a styrene unit, and
a plastic that comprises a styrene copolymer.

The combination of plastics may comprise
a plastic that comprises a styrene unit, and
a plastic that comprises a copolymer of an alkene and vinyl acetate.

The combination of plastics may comprise
a plastic that comprises a styrene unit, and
a plastic that comprises an acrylic polymer.

The combination of plastics may comprise
a plastic that comprises a styrene unit, and
a plastic that comprises a nylon based polymers or co-polymers.

The binder may comprise a plastic comprising a styrene based monomer and two other plastics. The combination of plastics may comprise
a plastic that comprises a styrene unit,
a plastic that comprises a styrene copolymer, and
a plastic that comprises a copolymer of an alkene and vinyl acetate.

The combination of plastics may comprise
a plastic that comprises a styrene unit,
a plastic that comprises a styrene copolymer, and
a plastic that comprises an acrylic polymer.

The combination of plastics may comprise
a plastic that comprises a styrene unit,
a plastic that comprises an acrylic polymer, and
a plastic that comprises a nylon based polymers or co-polymers.

The combination of plastics may comprise
a plastic that comprises a styrene unit,
a plastic that comprises a copolymer of an alkene and vinyl acetate, and
a plastic that comprises an acrylic polymer.

The combination of plastics may comprise
a plastic that comprises a styrene unit,
a plastic that comprises a copolymer of an alkene and vinyl acetate, and
a plastic that comprises a nylon based polymers or co-polymers.

The combination of plastics may comprise
a plastic that comprises a styrene unit,
a plastic that comprises an acrylic polymer, and
a plastic that comprises a nylon based polymers or co-polymers.

The binder may comprise a plastic comprising a styrene based monomer and three other plastics. The combination of plastics may comprise
a plastic that comprises a styrene unit,
a plastic that comprises a styrene copolymer,
a plastic that comprises a copolymer of an alkene and vinyl acetate,
a plastic that comprises an acrylic polymer, and

The combination of plastics may comprise
a plastic that comprises a styrene unit,
a plastic that comprises a styrene copolymer,
a plastic that comprises a copolymer of an alkene and vinyl acetate, and
a plastic that comprises a nylon based polymers or co-polymers.

The combination of plastics may comprise
a plastic that comprises a styrene unit,
a plastic that comprises a styrene copolymer,
a plastic that comprises an acrylic polymer, and
a plastic that comprises a nylon based polymers or co-polymers.

The combination of plastics may comprise
a plastic that comprises a styrene unit,
a plastic that comprises an acrylic polymer,
a plastic that comprises a copolymer of an alkene and vinyl acetate, and
a plastic that comprises a nylon based polymers or co-polymers.

The binder may comprise a plastic comprising a styrene based monomer and four other plastics. The combination of plastics may comprise
a plastic that comprises a styrene unit,
a plastic that comprises a styrene copolymer,
a plastic that comprises a copolymer of an alkene and vinyl acetate,
a plastic that comprises an acrylic polymer, and
a plastic that comprises a nylon based polymers or co-polymers.

The solvents for use with the combinations of plastics described may comprise a combination of solvents. For example, the binder composition may comprise a solvent system that comprise two or more solvents. In one embodiment the binder composition may comprise a solvent and co-solvent, wherein the solvent may have high solvating properties, and the co-solvent has relatively lower solvating properties. In one embodiment the co-solvent may account for 2, 4, 6, 8, 10, 12, 14, 16, 18 or 20% of the total amount of the solvent system, and suitable ranges may be selected from between any of these values, (for example, about 2 to about 20, about 2 to about 16, about 2 to about 14, about 2 to about 10, about 4 to about 20, about 4 to about 16, about 4 to about 14, about 4 to about 10, about 6 to about 20, about 6 to about 18, about 6 to about 14, about 6 to about 10, about 8 to about 20, about 8 to about 18, about 8 to about 14, about 10 to about 20, about 10 to about 18, about 10 to about 16, about 12 to about 20, about 12 to about 16, about 14 to about 20, about 14 to about 18, about 16 to about 20% of the total amount of the solvent system).

For example, the co-solvent may be one or more dearomatised solvents in combination with a solvent selected from an organohalide solvent, an aromatic hydrocarbon solvent, a mineral spirit or a combination thereof.

Some plastic combinations, or solvent and plastic combinations, may result in plastic agglomerations. In one embodiment the desired particle size is less than 0.5, 1, 2, 3, 4, 5, 6, 7, or 8 mm, and suitable ranges may be selected from between any of these values, (for example, about 0.5 to about 8, about 0.5 to about 6, about 0.5 to about 4, about 0.5 to about 2, about 1 to about 8, about 1 to about 7, about 1 to about 5, about 1 to about 4, about 2 to about 8, about 2 to about 7, about 2 to about 5, about 3 to about 8, about 3 to about 6, about 4 to about 8, about 4 to about 7 or about 5 to about 8 mm). When the particle size is above a desired particle size then the mixture may be processed through a homogenizer, such as a homogenizer as described above.

Where a homogenizer is included it may be fluidly connected with the mixing tank. That is, the mixing tank will have an outlet that is fluidly connected to an inlet of the homogenizer to convey material from the mixing tank to the homogenizer. The material in the mixing tank can then be processed by the homogenizer to reduce the particle size of plastics in the mixing tank to a desired size. The outlet of the homogenizer may feed back into the mixing tank, or it may feed into a storage tank to store the resultant plastic emulsion.

A benefit of the homogenisation process is that it increases the rate of dissolution of the plastic given an increase in surface area as the plastic particles reduce in size.

Additives may be added to the mixing tank. The additives may be selected from paints, oils, organic matter or marine plastic. The paint can be selected from acrylic paint, oil-based paint or water based paint. The oil may be selected from petroleum based oil, synthetic oil, vegetable oil or a combination thereof. The organic matter may be residual organic matter (i.e. from the original use of the plastic).

The additive may comprise 1, 2, 3, 4, 5, 6, 7, 8, 9, 10, 11, 12, 13, 14, 15, 16, 17, 18, 19 or 20% of the binder composition, and suitable ranges may be selected from between any of these values, (for example, about 1 to about 20, about 1 to about 18, about 1 to about 12, about 1 to about 10, about 2 to about 20, about 2 to about 16, about 2 to about 12, about 2 to about 10, about 3 to about 20, about 3 to about 17, about 3 to about 11, about 3 to about 10, about 4 to about 20, about 4 to about 18, about 4 to about 14, about 4 to about 10, about 5 to about 20, about 5 to about 18, about 5 to about 16, about 5 to about 14, about 6 to about 20, about 7 to about 20, about 7 to about 18, about 7 to about 15, about 7 to about 13, about 8 to about 20, about 8 to about 18, about 8 to about 14, about 9 to about 20, about 9 to about 14, about 10 to about 20, about 10 to about 15, about 11 to about 20, about 11 to about 17, about 12 to about 20, about 12 to about 19% of the binder composition).

The mixing tank may be heated. The heating of the mixing tank may assist the dissolution process, and particularly where plastics with a higher melting temperature are used. Where waste plastics are used it can be difficult, given the mixed nature of the shredded plastic, to know the exact composition of the plastic in the mixing tank. If there is a higher percentage of plastic that has a higher melting temperature then the heating of the mixing tank may be advantageous to speed the dissolution process.

For example, the mixing tank may be heat to a temperature of up to 30° C.

The rate of dissolution of the plastic is dependent on a number of variables, such as the composition of the plastic source, the solvents used, the plastic particle size and the temperature of the mixing tank. All of these variables can be adjusted to affect the rate of dissolution. For example, the rate of dissolution can be increased through controlling:
the composition of the plastic source, through the use of lower melt plastics such as styrene, acrylic, ABS and polypropylene,
the solvents use, since some solvent will dissolve certain plastics faster than others, such as methylene chloride and trichloroethylene,
the plastic particle size, since reducing the plastic particle size will increase the surface area of each plastic particle, and
the temperature of the mixing tank, by matching higher mixing tank temperatures to plastics with higher melt temperatures.

In one configuration the plastic source comprises a combination of ABS, EVA and acrylic and a solvent selected from an organohalide solvent, an aromatic hydrocarbon solvent, a mineral spirit, a dearomatised solvent or a combination thereof.

In one embodiment the binder and aggregate are mixed together at a temperature of less than about 30° C., and more preferably less than about 25° C.

In an alternate embodiment the binder and aggregate are mixed together at around 100, 110, 120, 130, 140, 150, 160, 170, 180, 190 or 200° C., and suitable ranges may be selected from between any of these values, (for example, about 100 to about 200, about 100 to about 180, about 100 to about 160, about 100 to about 140, about 110 to about 200, about 110 to about 190, about 110 to about 180, about 110 to about 160, about 120 to about 200, about 120 to about 190, about 120 to about 170, about 120 to about 150, about 130 to about 200, about 130 to about 180, about 130 to about 160, about 140 to about 200, about 140 to about 180, about 150 to about 200, about 150 to about 190, about 16 to about 200° C.).

In particular, the use of heating of the binder and aggregate mixture may occur when a high melt plastic is added to the binder and aggregate mixture. Shown in Table 2 below is melting point of various plastics.

TABLE 2
Plastic melting points

| | Melting |
|---|---|
| Plastic | point |
| ABS | 105 |
| EVA | 167-216 |
| Acrylic | 160 |
| Nylon | 220-270 |
| PET | 260 |
| Polypropylene | 160 |
| Polyethylene | 120-180 |

In one embodiment the plastic particles added to the binder-aggregate mixture comprises EVA, Nylon, PET, PP, high melt PE or a combination thereof.

While a temperature of 100 to 200° C. may be below the actual melting points of a plastic particle added to the binder-aggregate mixture, the inventors have found that the co-mingling of other plastics (with lower melt temperatures) is sufficient to promote or assist the melting of the high melt plastics.

In one embodiment a progressive heating system may be employed. That is, heating to a first temperature T₁ and then determining the dissolution characteristics of the composition in the mixing tank. If, for example T₁ is sufficient to dissolve the plastic in a desired time frame then heating may be maintained at T₁. If, however, the plastic is not dissolving as quickly as desired, then the mixing tank may be heated to a temperature T₂, where T₂ is a higher temperature than T₁.

If the plastic particles added to the binder-aggregate mixture comprises a higher proportion of plastics with a higher melting point (e.g. PET, Nylon or EVA) then a higher temperature may be used. For example, a temperature of about 140 to about 200° C., or a temperature of about 160 to about 200° C.

Without being limited by theory, the added heat may help to melt the plastic to the binder-coated aggregate.

The binder may be added to the aggregate followed by the plastic particles. Alternately, the binder may be mixed with the aggregate and the plastic particles art the same time.

A benefit of the heating process is that it maintains the plastic in a flowable viscous form that can be delivered to the site of road laying. That is, the emulsion mixed with aggregate acts as a heat sink to retain heat and can be delivered to a site of use (provided it is not too far away) and laid in the road forming process.

As shown in FIG. 2, the mixture in the mixing tank may be subjected to solvent recovery such as shown in FIG. 4 and described from paragraph [0313] above. The solvent recovery process remove 3, 4, 5, 6, 7, 8, 9, 10, 11, 12, 13, 14, 15, 16, 17, 18, 19 or 20% of the solvent from the mixture in the mixing tank, and suitable ranges may be selected from between any of these values, (for example, about 3 to about 20, about 3 to about 18, about 3 to about 15, about 3 to about 10, about 3 to about 8, about 3 to about 6, about 4 to about 20, about 4 to about 17, about 4 to about 12, about 4 to about 9, about 4 to about 7, about 4 to about 6, about 5 to about 20, about 5 to about 19, about 5 to about 18, about 5 to about 11, about 5 to about 9, about 6 to about 20, about 6 to about 18, about 6 to about 16, about 6 to about 10, about 7 to about 20, about 7 to about 19, about 7 to about 13, about 8 to about 20, about 8 to about 18, about 8 to about 16, about 9 to about 20, about 9 to about 17, about 9 to about 14, about 10 to about 20, about 10 to about 17, about 10 to about 15, about 11 to about 20, about 11 to about 17, about 12 to about 20, about 12 to about 18, about 12 to about 16, about 13 to about 20, about 13 to about 18, about 13 to about 16, about 14 to about 20, 14 to about 17 or about 15 to about 20% of the solvent).

The use of solvent recovery can be used to increase the viscosity of the mixture to produce an emulsion with a viscosity of about 1,000, 2,000, 3,000, 4,000, 5000, 6,000, 7,000, 8,000, 9,000, 10,000, 11,000, 12,000, 13,000, 14000, 15,000, 16,000, 17,000, 18,000, 19,000 or 20,000 cP, and suitable ranges may be selected from between any of these values, (for example, about 1,000 to about 20,000, about 1,000 to about 17,000, about 1,000 to about 15,000, about 1,000 to about 10,000, about 1,000 to about 8,000, about 1,000 to about 6,000, about 1,000 to about 4,000, about 2,000 to about 20,000, about 2,000 to about 18,000, about 2,000 to about 15,000, about 2,000 to about 10,000, about 2,000 to about 8,000, about 2,000 to about 6,000, about 3,000 to about 20,000, about 3,000 to about 10,000, about 3,000 to about 9,000, about 3,000 to about 6,000, about 4,000 to about 20,000, about 4,000 to about 10,000, about 4,000 to about 8,000, about 5,000 to about 20,000, about 5,000 to about 15,000, about 5,000 to about 10,000, about 5,000 to about 9,000, about 6,000 to about 20,000, about 6,000 to about 15,000, about 6,000 to about 10,000, about 7,000 to about 20,000, about 7,000 to about 16,000, about 8,000 to about 20,000, about 8,000 to about 16,000, about 9,000 to about 20,000, about 9,000 to about 15,000, about 10,000 to about 20,000 cP).

In one embodiment a higher amount of solvent is removed by solvent recovery and substituted with another solvent. This may be done to, for example, substitute in a solvent that is more environmentally friendly that the solvent that it is substituting. For example, organohalide solvents or aromatic hydrocarbon solvent may be less environmentally than dearomatised solvents as mentioned above (e.g. Exxsol and ShellSol range of solvents). That is, the total solvent recovery may be above the 3 to about 20% as mentioned above, yet the effective solvent recovery level is not changed since the total solvent content is maintained through the substitution of a more environmentally friendly solvent.

The emulsion binder may comprise 50, 60, 70, 80, 90 or 95% solids, about and suitable ranges may be selected from between any of these values, about (for example, about 50 to about 95, about 50 to about 80, about 50 to about 7 to about , about 55 to about 95, about 55 to about 90, about 55 to about 85, about 60 to about 95, about 60 to about 90, about 60 to about 75, about 65 to about 95, about 65 to about 85, about 70 to about 95, about 70 to about 90, about 70 to about 85, about 75 to about 95, about 75 to about 90, about 75 to about 85, about 80 to about 95, about 80 to about 90% total solids).

The resultant emulsion binder can be used in roading manufacture.

The emulsion binder may be combined with aggregate to coat the aggregate with the emulsion.

Alternately the binder may derived from the monomer based binder system.

The relative amount of binder to aggregate may depend on the size of the aggregate. For example, the roading composition (comprising aggregate and binder) may comprise about 7, 8, 9, 10, 11, 12, 13, 14 or 15% binder, and suitable ranges may be selected from between any of these values (for example, about 7 to about 15, about 7 to about 12, about 7 to about 10, about 8 to about 15, about 8 to about 14, about 8 to about 11, about 9 to about 15, about 9 to about 13, about 9 to about 12, about 10 to about 15, about 10 to about 12 or about 13 to about 15% binder). That is the ratio of binder to aggregate may be about 1:8 to about 1:14, and suitable ranges may be selected from between any of these values.

The aggregate may have an average size of about 1 to 20 mm, and suitable ranges may be selected from between any of these values.

A road may comprise multiple layers. For example, a paving layer as the lowermost layer, a sub-base and a top layer. In a typical road, the paving may be formed from concrete, with the subbase formed from a bitumen mix with or without aggregate, and then the top layer is a bitumen mix combined with aggregate (i.e. fines).

As the emulsion can replace bitumen in the road manufacturing process, the emulsion can be used in any one or more of these layers.

For example, in relation to the paving layer, this may be 200 to 300 mm in depth and may comprise a mixture of the emulsion combined with larger aggregate, such as aggregate having an average size of between 20 to about 30 mm.

In relation to the sub-base layer, this may comprise a 50 to 60 mm layer comprising a mixture of binder and aggregate having the average particle size of 1 to 5 mm as described above. In some embodiments, the aggregate used here is undissolved plastic that has been reduced in size to 1 to 5 mm particles. In one configuration the subbase layer may comprise only binder.

The aggregate, binder and optionally the plastic particle, may be mixed in situ, applied to the road and then rolled to form the road surface.

During the mixing process the additive (i.e. paint or oil) may be added.

In one embodiment the binder-aggregate mixture (absent any undissolved plastic particles) may be mixed with the additive. In such an embodiment the roading mixture may be heated to 20, 25, 30, 35, 40, 45, or 50° C., and suitable ranges may be selected from between any of these values (for example, about 20 to about 50, about 20 to about 45, about 20 to about 40, about 20 to about 30, about 25 to about 50, about 25 to about 40, about 25 to about 35, about 25 to about 30, about 30 to about 50, about 30 to about 40, about 35 to about 50° C.).

In relation to the top layer this may be formed of the traditional bitumen-aggregate (fines) mixture, or the bitumen may be replaced by the binder. In some configuration the aggregate may be provided by plastic aggregate that is undissolved and that has been reduced in size to 1 to 5 mm particles.

Each layer is compressed after laying, such as by road rollers which process is well known in road manufacture. During the laying process, the binder-aggregate mixture may be held in a truck and dispensed on to the road. The truck may include a solvent recovery system that assists in recovering volatile solvent that escapes from the roading mixture during the laying process.

In one embodiment the binder may be applied via an in situ process and can be used with both aggregate for new road surface or reconstructing a previously laid road surface, mixing the old reground aggregate with new heated binder and relayed in situ.

The binder as described may be used to manufacture composite plastic products. The binder may be combined with a fibre or waste material selected from one or more of:
hemp,
wood sawdust (industry wood fibre flakes),
shredded paper (cardboard fibre),
polyethylene Woven Bags,
polyethylene Bags,
PET bottles,
crushed glass,
crushed toys or electronics (e.g. TV backings, printer cartridges),
volcanic ash and pot ash, and/or
rubber/tyres and carbon black (granulated tyres).

The binder may be combined with the fibre and/or waste material such that the binder substantially coats the fibre and/or waste material to produce a mouldable mixture. The mouldable mixture may then be injected into a mould to produce the final product.

As discussed above, the binder is formed from at least a mixture of plastics and solvent as shown in FIG. 2.

The solvent may be selected from
a) water,
b) an organohalide solvent, an aromatic hydrocarbon solvent, a mineral spirit, a dearomatised solvent or a combination thereof as discussed in paragraphs [0200] to [0212] above,
c) a monomer as described in paragraphs [0323] to, or
d) a combination of (a) and (b).

The plastics source may comprise a combination of plastics. The plastics may be selected from a plastic that comprises a styrene based monomer, a styrene copolymer, a copolymer of an alkene and vinyl acetate, acrylic polymer and nylon based polymers or co-polymers, or combination thereof.

The combination of plastic may include a plastic that comprises a styrene based monomer.

The styrene based monomer may be polymerised (facilitated by the vinyl group) to form a homo- or copolymer. For example, the styrene based monomer may polymerise as a homopolymer to form polystyrene.

The styrene based monomer may form a co-polymer with one or more other compounds. For example,
with acrylonitrile in the presence of polybutadiene for example to form acrylonitrile butadiene styrene (ABS),
with butadiene for example to form styrene-butadiene or styrene-isoprene-styrene,
with ethylene and/or butylene for example to form styrene-ethylene-butylene-styrene (S-BE-S),
with divinylbenzene for example to form styrene-divinylbenzene (S-DVB),
with acrylonitrile to for example form styrene acrylonitrile (SAN),
with unsaturated polyesters that are typically used in resins and thermosetting compounds.

The styrene copolymer may be a polymer of styrene and acrylonitrile, such as acrylonitrile butadiene styrene (ABS). Given the binder is a combination of two or more different plastics, where one of the plastics is a polymer of styrene and acrylonitrile, the other plastic polymer is not a polymer of styrene and acrylonitrile.

The copolymer of an alkene may be a copolymer of ethylene. The copolymer of ethylene may be, for example, a copolymer of ethylene and vinyl acetate. The copolymer of ethylene and vinyl acetate may be ethylene-vinyl acetate (EVA).

The acrylic polymer may be poly(methyl methacrylate).

The nylon based polymers or co-polymers are typically aliphatic or semi-aromatic polyamides.

The plastic may comprise a polyester-based thermoplastic polymer resin or a homo-polymer of an alkene.

The polyester-based thermoplastic polymer resin may be polyethylene terephthalate (PET). The propylene-based thermoplastic polymer may be polypropylene (PP). The homo-polymer of an alkene may be a homo-polymer of ethylene. The homo-polymer of ethylene may be polyethylene (PE)(including high and low density polyethylene).

In some configurations the plastic may be a virgin plastic. In such a case it may be necessary to add a cross linker to the virgin plastic as is done during the thermosetting process for plastic products. Common cross linkers lead to cross-linking based on peroxide cross-linking, radiation cross-linking and silane cross-linking.

The solvent may be selected from water, an organohalide solvent, an aromatic hydrocarbon solvent, a mineral spirit, a dearomatised solvent or a combination thereof as discussed in paragraphs [0202] to [0212] above.

The solvent and plastic are mixed together in the mixing tank.

The plastic may be in a number of forms. Such as:
a) chipped plastic,
b) plastic that has been processed to a particle size of less than 0.5 mm,
c) plastic (or a portion thereof) that has been dissolved in a solvent, or
d) any combination of (a) to (c).

The chipped plastic may be produced by any process that reduces the plastic to a particle size of between 8, 9, 10, 11, 12, 13, 14, 15, 16, 17, 18, 19 or 20 mm. Various methods are known such as shredding, granulation and grinding.

In relation to shredding, the plastic is preferably first shredded to a particle size of less than 20 mm. Preferably the shredded plastic has a particle size of about 2, 3, 4, 5, 6, 7, 8, 9, 10, 11, 12, 13, 14, 15, 16,1 7, 18, 19 or 20 mm, and suitable ranges may be selected from between any of these values, (for example, about 2 to about 20, about 2 to about 10, about 2 to about 8, about 2 to about 6, about 2 to about 5, about 3 to about 10, about 3 to about 9, about 3 to about 8, about 3 to about 6, about 4 to about 10, about 4 to about 8, about 4 to about 6, about 5 to about 10, about 5 to about 9 or about 6 to about 10 mm).

In relation to a plastic that has been processed to a particle size of less than 20 mm, such plastic may be processed by a homogenizer such as that described above from paragraph [0234]. For example, the homogenizer may comprise of a machine having a series of rotating cylinders.

A further source of plastic could thus include homogenised slurry of plastic having a particle size of less than about 2 mm.

The plastic (or a portion thereof) that has been dissolved in a solvent may be any plastic that is dissolvable in a solvent. For example, the plastic may be a homopolymer of a styrene based monomer or ethylene monomer. The plastic may comprise a copolymer of an alkene and vinyl acetate, acrylic polymer or be a nylon based polymers or co-polymers.

The dissolved (or portion thereof) may be dissolved (or at least partially dissolved) prior to addition into the mixing tank. In the case where the plastic is partially dissolved, the plastic may be completely dissolved in the mixing tank. The dissolvable plastic may be dissolved in the mixing tank.

Multiple types of plastics may be mixed in the mixing tank. For example, a combination of dissolvable plastics and chipped plastic, or a combination of dissolvable plastics and processed plastic, or a combination of chipped plastic and processed plastic.

The binder may be a water based binder. One or more plastics selected from a polyester-based thermoplastic polymer resin propylene-based thermoplastic polymer and homo-polymer of an alkene (e.g. HDPE, LDPE, PVC, PE, PP, PET), may be combined in the mixing tank with water. The water based binder may comprise:
a polyester-based thermoplastic polymer resin,
propylene-based thermoplastic polymer, or
homo-polymer of an alkene.

The water based binder may comprise:
a polyester-based thermoplastic polymer resin, and
propylene-based thermoplastic polymer.

The water based binder may comprise:
a polyester-based thermoplastic polymer resin, and
homo-polymer of an alkene.

The water based binder may comprise:
propylene-based thermoplastic polymer, and
homo-polymer of an alkene.

The water based binder may comprise:
a polyester-based thermoplastic polymer resin,
propylene-based thermoplastic polymer, and
homo-polymer of an alkene.

The solvents for use with the combinations of plastics described may comprise a combination of solvents. For example, the binder composition may comprise a solvent system that comprise two or more solvents. In one embodiment the binder composition may comprise a solvent and co-solvent, wherein the solvent may have high solvating properties, and the co-solvent has relatively lower solvating properties. In one embodiment the co-solvent may account for 2, 4, 6, 8, 10, 12, 14, 16, 18 or 20% of the total amount of the solvent system, and suitable ranges may be selected from between any of these values, (for example, about 2 to about 20, about 2 to about 16, about 2 to about 14, about 2 to about 10, about 4 to about 20, about 4 to about 16, about 4 to about 14, about 4 to about 10, about 6 to about 20, about 6 to about 18, about 6 to about 14, about 6 to about 10, about 8 to about 20, about 8 to about 18, about 8 to about 14, about 10 to about 20, about 10 to about 18, about 10 to about 16, about 12 to about 20, about 12 to about 16, about 14 to about 20, about 14 to about 18, about 16 to about 20% of the total amount of the solvent system).

For example, the co-solvent may be one or more dearomatised solvents in combination with a solvent selected from an organohalide solvent, an aromatic hydrocarbon solvent, a mineral spirit or a combination thereof.

Some plastic combinations, or solvent and plastic combinations, may result in plastic agglomerations or plastic particle sizes above a desired size. In one embodiment the desired particle size is less than 0.5, 1, 2, 3, 4, 5, 6, 7, or 8 mm, and suitable ranges may be selected from between any of these values, (for example, about 0.5 to about 8, about 0.5 to about 6, about 0.5 to about 4, about 0.5 to about 2, about 1 to about 8, about 1 to about 7, about 1 to about 5, about 1 to about 4, about 2 to about 8, about 2 to about 7, about 2 to about 5, about 3 to about 8, about 3 to about 6, about 4 to about 8, about 4 to about 7 or about 5 to about 8 mm). When the particle size s above a desired particle size then the mixture may be processed through a homogenizer, such as a homogenizer as described above.

Where a homogenizer is included it may fluidly connected with the mixing tank. That is, the mixing tank will have an outlet that is fluidly connected to an inlet of the homogenizer to convey material from the mixing tank to the homogenizer. The material in the mixing tank can then be processed by the homogenizer to reduce the particle size of plastics in the mixing tank to a desired size. The outlet of the homogenizer may feed back into the mixing tank, or it may feed into a storage tank to store the resultant plastic emulsion.

A benefit of the homogenisation process is that it increases the rate of dissolution of the plastic given an increase in surface area as the plastic particles reduce in size.

The mixing tank may be heated. In one embodiment the binder is heated at a temperature of less than about 30° C., and more preferably less than about 25° C.

The heating of the mixing tank may assist the dissolution process, and particularly where plastics with a higher melting temperature are used. Where waste plastics are used it can be difficult, given the mixed nature of the shredded plastic, to know the exact composition of the plastic in the mixing tank. If there is a higher percentage of plastic that has a higher melting temperature then the heating of the mixing tank may be advantageous to speed the dissolution process.

Where the composition of the plastic source is unknown a progressive heating system may be employed. That is, heating to a first temperature T₁ and then determining the dissolution characteristics of the composition in the mixing tank. If, for example T₁ is sufficient to dissolve the plastic in a desired time frame then heating may be maintained at T₁. If, however, the plastic is not dissolving as quickly as desired, then the mixing tank may be heated to a temperature T₂, where T₂ is a higher temperature than T₁.

The rate of dissolution of the plastic is dependent on a number of variables, such as the composition of the plastic source, the solvents used, the plastic particle size and the temperature of the mixing tank. All of these variables can be adjusted to affect the rate of dissolution. For example, the rate of dissolution can increased through controlling:
the composition of the plastic source, through the use of lower melt plastics such as styrene, acrylic, ABS and polypropylene,
the solvents use, since some solvent will dissolve certain plastics faster than others, such as methylene chloride and trichloroethylene,
the plastic particle size, since reducing the plastic particle size will increase the surface area of each plastic particle, and
the temperature of the mixing tank, by matching higher mixing tank temperatures to plastics with higher melt temperatures.

As shown in FIG. 2, the mixture in the mixing tank may be subjected to solvent recovery such as shown in FIG. 4 and described from paragraph [0313] above. The solvent recovery process remove 3, 4, 5, 6, 7, 8, 9, 10, 11, 12, 13, 14, 15, 16, 17, 18, 19 or 20% of the solvent from the mixture in the mixing tank, and suitable ranges may be selected from between any of these values, (for example, about 3 to about 20, about 3 to about 18, about 3 to about 15, about 3 to about 10, about 3 to about 8, about 3 to about 6, about 4 to about 20, about 4 to about 17, about 4 to about 12, about 4 to about 9, about 4 to about 7, about 4 to about 6, about 5 to about 20, about 5 to about 19, about 5 to about 18, about 5 to about 11, about 5 to about 9, about 6 to about 20, about 6 to about 18, about 6 to about 16, about 6 to about 10, about 7 to about 20, about 7 to about 19, about 7 to about 13, about 8 to about 20, about 8 to about 18, about 8 to about 16, about 9 to about 20, about 9 to about 17, about 9 to about 14, about 10 to about 20, about 10 to about 17, about 10 to about 15, about 11 to about 20, about 11 to about 17, about 12 to about 20, about 12 to about 18, about 12 to about 16, about 13 to about 20, about 13 to about 18, about 13 to about 16, about 14 to about 20, 14 to about 17 or about 15 to about 20% of the solvent).

The use of solvent recovery can be used to increase the viscosity of the mixture to produce an emulsion with a viscosity of about 1,000, 2,000, 3,000, 4,000, 5000, 6,000, 7,000, 8,000, 9,000, 10,000, 11,000, 12,000, 13,000, 14000, 15,000, 16,000, 17,000, 18,000, 19,000 or 20,000 cP, and suitable ranges may be selected from between any of these values, (for example, about 1,000 to about 20,000, about 1,000 to about 17,000, about 1,000 to about 15,000, about 1,000 to about 10,000, about 1,000 to about 8,000, about 1,000 to about 6,000, about 1,000 to about 4,000, about 2,000 to about 20,000, about 2,000 to about 18,000, about 2,000 to about 15,000, about 2,000 to about 10,000, about 2,000 to about 8,000, about 2,000 to about 6,000, about 3,000 to about 20,000, about 3,000 to about 10,000, about 3,000 to about 9,000, about 3,000 to about 6,000, about 4,000 to about 20,000, about 4,000 to about 10,000, about 4,000 to about 8,000, about 5,000 to about 20,000, about 5,000 to about 15,000, about 5,000 to about 10,000, about 5,000 to about 9,000, about 6,000 to about 20,000, about 6,000 to about 15,000, about 6,000 to about 10,000, about 7,000 to about 20,000, about 7,000 to about 16,000, about 8,000 to about 20,000, about 8,000 to about 16,000, about 9,000 to about 20,000, about 9,000 to about 15,000, about 10,000 to about 20,000 cP).

In one embodiment a higher amount of solvent is removed by solvent recovery and substituted with another solvent. This may be done to, for example, substitute in a solvent that is more environmentally friendly that the solvent that it is substituting. For example, organohalide solvents or aromatic hydrocarbon solvent may be less environmentally acceptable than dearomatised solvents as mentioned above (e.g. Exxsol and ShellSol range of solvents). That is, the total solvent recovery may be above the 3 to about 20% as mentioned above, yet the effective solvent recovery level is not changed since the total solvent content is maintained through the substitution of a more environmentally friendly solvent.

In one embodiment the emulsion containing organic solvent is subjected to solvent recovery. As the solvent is evaporated from the emulsion preferably warm water takes its place in volume. When this is complete and the solvent has been removed (as much as possible) then the solvent is chilled and returned to the solvent holding tank. The resulting emulsion (containing the particulate matter or fibre) may then be pumped to a storage tank. The emulsion may also comprise a surfactant to stabilise the emulsion.

The emulsion may comprise 50, 60, 70, 80, 90 or 95% solids, about and suitable ranges may be selected from between any of these values, about (for example, about 50 to about 95, about 50 to about 80, about 50 to about 70, about 55 to about 95, about 55 to about 90, about 55 to about 85, about 60 to about 95, about 60 to about 90, about 60 to about 75, about 65 to about 95, about 65 to about 85, about 70 to about 95, about 70 to about 90, about 70 to about 85, about 75 to about 95, about 75 to about 90, about 75 to about 85, about 80 to about 95, about 80 to about 90% total solids).

The resultant emulsion can be used to manufacture composite products, such as posts, poles, boards or blocks.

The emulsion may be combined with the fibres to coat the fibres with the emulsion. The relative amount of emulsion to fibre may depend on the size of the fibre. For example, the composite product composition (comprising fibre and binder) may comprise about 7, 8, 9, 10, 11, 12, 13, 14 or 15% binder, and suitable ranges may be selected from between any of these values (for example, about 7 to about 15, about 7 to about 12, about 7 to about 10, about 8 to about 15, about 8 to about 14, about 8 to about 11, about 9 to about 15, about 9 to about 13, about 9 to about 12, about 10 to about 15, about 10 to about 12 or about 13 to about 15% binder). That is the ratio of binder to fibre may be about 1:8 to about 1:14, and suitable ranges may be selected from between any of these values.

The emulsion-fibre mixture may then be injected or poured into a mould. Once the mould is closed, pressure may be applied to the mould to compress the mould. Heat may also be applied to the mould.

In one embodiment the mould may be progressively closed, based on the amounts of posture in the fibre.

In one embodiment the binder is used to make plywood. In such an embodiment the binder is sprayed between the plywood players prior to compression of the layers to each other. In one embodiment the binder is sprayed in a layer of about 0.1, 1, 1.5, 2, 2.5, 3, 3.5 or 4 mm, and suitable ranges may be selected from between any of these values.

In one configuration, the binder is made from a combination of two plastic binder compositions: one being water based and one being solvent based. The binder is then combined with a waste material (e.g. wood fibre materials such as sawdust used in MDF, wood fibre used in particle board, waste materials such as paper and cardboard fibre, granulated rubber, ground glass, other waste unrecyclable plastics such as ocean sourced waste plastics, PP and waste PET, pumice, other volcanic materials, rice and coconut husk).

In such an embodiment where a binder is made from a water based and solvent based binder, the solvent based binder is subjected to solvent recovery to remove about 80, 85, 90, 95 or 99% of the solvent, and suitable ranges may be selected from between any of these values.

### EXAMPLES

### 1. Example 1—Cold Roading

The purpose of this test was to examine the properties of the emulsion in a cold roading production process.

Four samples were tested (1 to 4). Samples 1 and 2 are paired replicates. Samples 3 and 4 are paired replicates. Sample 1 and 2 differ from samples 3 and 4 by the amount of binder in them.

Samples 1 and 2 were formed using ABS (1 kg), acrylic (1 kg) and styrene (1 kg). Samples 3 and 4 were formed using ABS (1 kg), acrylic (1 kg) and styrene (1.5 kg). The plastic was dissolved in a 1:1 ratio of trichlorethylene and methylene chloride to a weight of 2 kg solvent. Approximately 2 mg of colourant was added to the 10 L bucket.

A simple test was used to determine when the plastic was suitably dissolved. A stainless steel rule was placed in the bucket containing the dissolve plastic and solvent. Once the steel rule was removed, the process was deemed complete when the emulsion dripped off the steel rule. If the emulsion ran off the steel rule, then the process was not deemed complete.

Aggregate was then added to the plastic emulsion. With this test the very small aggregates were excluded (i.e. sand). This test used 8-9 mm aggregate which was found to give a better result. The resultant mix was put into briquette moulds (in the shape of a cylinder) and left to harden (meaning the chemicals had evaporated out).

The samples shown in Table 3 and Table 4 used 10% of the emulsion by weight.

TABLE 3
Results of indirect tensile strength tests.

| | | | | Ring | | | |
|---|---|---|---|---|---|---|---|
| | Height | Diameter | Mass | Load | Load | ITS | Density |
| Sample | (mm) | (mm) | (g) | (Divs) | (kN) | (kPa) | (t/m³) |
| 1 | 62.2 | 99.9 | 931.6 | 25600 | 25.6 | 2622 | 1.91 |
| 2 | 63.9 | 99.9 | 957.6 | 22200 | 22.2 | 2215 | 1.91 |
| 3 | 63.1 | 99.9 | 935.7 | 21100 | 21.1 | 2133 | 1.89 |
| 4 | 64.0 | 99.9 | 948.8 | 21600 | 21.6 | 2151 | 1.89 |

TABLE 4
Results of indirect tensile strength testing showing resilient modulus
results

| | | Resilient |
|---|---|---|
| | | modulus |
| Sample | Temperature | (MPa) |
| 1 | 24.4 | 24591 |
| 2 | 24.4 | 24218 |
| 3 | 24.4 | 21090 |
| 4 | 24.3 | 20425 |

The samples shown in Table 5 and Table 6 used 8% of the emulsion by weight.

TABLE 5
Results of indirect tensile strength tests.

| | | | | Ring | | | |
|---|---|---|---|---|---|---|---|
| | Height | Diameter | Mass | Load | Load | ITS | Density |
| Sample | (mm) | (mm) | (g) | (Divs) | (kN) | (kPa) | (t/m³) |
| 1 | 63.4 | 99.9 | 926.0 | 710 | 15.9 | 1601 | 1.865 |
| 2 | 66.0 | 99.9 | 955.4 | 540 | 12.1 | 1172 | 1.848 |
| 3 | 68.0 | 99.9 | 986.7 | 536 | 12.0 | 1128 | 1.851 |
| 4 | 68.9 | 99.9 | 984.3 | 440 | 9.9 | 916 | 1.825 |

TABLE 6
Results of indirect tensile strength testing showing resilient modulus
results

| | | Resilient |
|---|---|---|
| | | modulus |
| Sample | Temperature | (MPa) |
| 1 | 24.1 | 13250 |
| 2 | 24.1 | 13386 |
| 3 | 24.2 | 10887 |
| 4 | 24.4 | 7482 |

The briquettes were subject to testing. The first was to insert a chisel into the top of the briquette. The force required is shown in Newtons. The higher the force means the harder the briquette.

A second test is where a strip of the roading sample was placed into a machine that bends them. The machine is run until the sample snaps. The results above show that the samples outperform bitumen.

### 2. Preparation of Binder

The table below summarizes the binder formulations that have been prepared and tested. The solvent was combined with the plastic source.

TABLE 7
Preparation of binders that have been prepared.

| | | % w/w | | % w/w |
|---|---|---|---|---|
| Binder | Class | of total | Component | of class |
| A | Solvent | 40 | Trichloroethylene | 90 |
| | | | Methylene chloride | 10 |
| | Plastic source | 60 | p-Styrene | 60 |
| | | | ABS | 15 |
| | | | EVA | 15 |
| | | | Acrylic | 10 |
| B-5 | Solvent | 36.4 | Trichloroethylene | 90 |
| | | | Methylene chloride | 10 |
| | Plastic source | 54.5 | p-Styrene | 60 |
| | | | ABS | 15 |
| | | | EVA | 15 |
| | | | Acrylic | 10 |
| | Chipped plastic | 9.1 | Ocean Plastic | 15 |
| | | | PP | 15 |
| | | | PET | 10 |
| B-10 | Solvent | 36.4 | Trichloroethylene | 90 |
| | | | Methylene chloride | 10 |
| | Plastic source | 54.5 | p-Styrene | 60 |
| | | | ABS | 15 |
| | | | EVA | 15 |
| | | | Acrylic | 10 |
| | Chipped plastic | 9.1 | Ocean Plastic | 3 |
| | | | PP | 3 |
| | | | PET | 4 |
| C-5 | Solvent | 36.4 | Trichloroethylene | 90 |
| | | | Methylene chloride | 10 |
| | Plastic source | 54.5 | p-Styrene | 60 |
| | | | ABS | 15 |
| | | | EVA | 15 |
| | | | Acrylic | 10 |
| | Non-plastic | 9.1 | Paint and engineering | 6 |
| | waste | | oils | |
| | | | Food | 4 |
| C-10 | Solvent | 36.4 | Trichloroethylene | 90 |
| | | | Methylene chloride | 10 |
| | Plastic source | 54.5 | p-Styrene | 60 |
| | | | ABS | 15 |
| | | | EVA | 15 |
| | | | Acrylic | 10 |
| | Non-plastic | 9.1 | Paint and engineering | 6 |
| | waste | | oils | |
| | | | Food | 4 |
| D | Monomer | 63 | MMA | 69 |
| | | | 2-EHA | 22 |
| | | | TMPTA | 9 |
| | Plastic source | 31 | p-Styrene | 100 |

2.1 Other Binder Formulations

The following binder formulations may be prepared. Solvent is added to the plastic source to form the binder mixture.

TABLE 8
Manufacture of the binder prepared from Styrene + one other plastic

| | | % w/w | | % w/w |
|---|---|---|---|---|
| Binder | Class | of total | Component | of class |
| Al | Solvent | 40 | organohalide solvent | 100 |
| | Plastic source | 60 | p-Styrene | 60 |
| | | | ABS | 40 |
| A2 | Solvent | 40 | aromatic hydrocarbon | 100 |
| | Plastic source | 60 | p-Styrene | 60 |
| | | | ABS | 40 |
| A3 | Solvent | 40 | aromatic hydrocarbon | 20 |
| | | | dearomatised solvent | 80 |
| | Plastic source | 60 | p-Styrene | 60 |
| | | | ABS | 40 |
| A4 | Solvent | 40 | organohalide solvent | 100 |
| | Plastic source | 60 | p-Styrene | 60 |
| | | | EVA | 40 |
| A5 | Solvent | 40 | aromatic hydrocarbon | 100 |
| | Plastic source | 60 | p-Styrene | 60 |
| | | | EVA | 40 |
| A6 | Solvent | 40 | aromatic hydrocarbon | 20 |
| | | | dearomatised solvent | 80 |
| | Plastic source | 60 | p-Styrene | 60 |
| | | | EVA | 40 |
| A7 | Solvent | 40 | organohalide solvent | 100 |
| | Plastic source | 60 | p-Styrene | 60 |
| | | | acrylic | 40 |
| A8 | Solvent | 40 | aromatic hydrocarbon | 100 |
| | Plastic source | 60 | p-Styrene | 60 |
| | | | acrylic | 40 |
| A9 | Solvent | 40 | aromatic hydrocarbon | 20 |
| | | | dearomatised solvent | 80 |
| | Plastic source | 60 | p-Styrene | 60 |
| | | | acrylic | 40 |
| B1 | Solvent | 60 | organohalide solvent | 100 |
| | Plastic source | 40 | p-Styrene | 60 |
| | | | ABS | 40 |
| B2 | Solvent | 60 | aromatic hydrocarbon | 100 |
| | Plastic source | 40 | p-Styrene | 60 |
| | | | ABS | 40 |
| B3 | Solvent | 60 | aromatic hydrocarbon | 20 |
| | | | dearomatised solvent | 80 |
| | Plastic source | 40 | Styrene | 60 |
| | | | ABS | 40 |
| B4 | Solvent | 60 | organohalide solvent | 100 |
| | Plastic source | 40 | p-Styrene | 60 |
| | | | EVA | 40 |
| B5 | Solvent | 60 | aromatic hydrocarbon | 100 |
| | Plastic source | 40 | p-Styrene | 60 |
| | | | EVA | 40 |
| B6 | Solvent | 60 | aromatic hydrocarbon | 20 |
| | | | dearomatised solvent | 80 |
| | Plastic source | 40 | p-Styrene | 60 |
| | | | EVA | 40 |
| B7 | Solvent | 60 | organohalide solvent | 100 |
| | Plastic source | 40 | p-Styrene | 60 |
| | | | acrylic | 40 |
| B8 | Solvent | 60 | aromatic hydrocarbon | 100 |
| | Plastic source | 40 | p-Styrene | 60 |
| | | | acrylic | 40 |
| B9 | Solvent | 60 | aromatic hydrocarbon | 20 |
| | | | dearomatised solvent | 80 |
| | Plastic source | 40 | p-Styrene | 60 |
| | | | acrylic | 40 |
| C1 | Solvent | 40 | organohalide solvent | 100 |
| | Plastic source | 60 | p-Styrene | 30 |
| | | | ABS | 70 |
| C2 | Solvent | 40 | aromatic hydrocarbon | 100 |
| | Plastic source | 60 | p-Styrene | 30 |
| | | | ABS | 70 |
| C3 | Solvent | 40 | aromatic hydrocarbon | 20 |
| | | | dearomatised solvent | 80 |
| | Plastic source | 60 | p-Styrene | 30 |
| | | | ABS | 70 |
| C4 | Solvent | 40 | organohalide solvent | 100 |
| | Plastic source | 60 | p-Styrene | 30 |
| | | | EVA | 70 |
| C5 | Solvent | 40 | aromatic hydrocarbon | 100 |
| | Plastic source | 60 | p- | 30 |
| | | | EVA | 70 |
| C6 | Solvent | 40 | aromatic hydrocarbon | 20 |
| | | | dearomatised solvent | 80 |
| | Plastic source | 60 | p-Styrene | 30 |
| | | | EVA | 70 |
| C7 | Solvent | 40 | organohalide solvent | 100 |
| | Plastic source | 60 | p-Styrene | 30 |
| | | | acrylic | 70 |
| C8 | Solvent | 40 | aromatic hydrocarbon | 100 |
| | Plastic source | 60 | p-Styrene | 30 |
| | | | acrylic | 70 |
| C9 | Solvent | 40 | aromatic hydrocarbon | 20 |
| | | | dearomatised solvent | 80 |
| | Plastic source | 60 | p-Styrene | 30 |
| | | | acrylic | 70 |
| D1 | Solvent | 50 | organohalide solvent | 100 |
| | Plastic source | 50 | p-Styrene | 30 |
| | | | ABS | 70 |
| D2 | Solvent | 50 | aromatic hydrocarbon | 100 |
| | Plastic source | 50 | p-Styrene | 30 |
| | | | ABS | 70 |
| D3 | Solvent | 50 | aromatic hydrocarbon | 20 |
| | | | dearomatised solvent | 80 |
| | Plastic source | 50 | p-Styrene | 30 |
| | | | ABS | 70 |
| D4 | Solvent | 50 | organohalide solvent | 100 |
| | Plastic source | 50 | p-Styrene | 30 |
| | | | EVA | 70 |
| D5 | Solvent | 50 | aromatic hydrocarbon | 100 |
| | Plastic source | 50 | p-Styrene | 30 |
| | | | EVA | 70 |
| D6 | Solvent | 50 | aromatic hydrocarbon | 20 |
| | | | dearomatised solvent | 80 |
| | Plastic source | 50 | p-Styrene | 30 |
| | | | EVA | 70 |
| D7 | Solvent | 50 | organohalide solvent | 100 |
| | Plastic source | 50 | p-Styrene | 30 |
| | | | acrylic | 70 |
| D8 | Solvent | 50 | aromatic hydrocarbon | 100 |
| | Plastic source | 50 | p-Styrene | 30 |
| | | | acrylic | 70 |
| D9 | Solvent | 50 | aromatic hydrocarbon | 20 |
| | | | dearomatised solvent | 80 |
| | Plastic source | 50 | p-Styrene | 30 |
| | | | acrylic | 70 |
| E1 | Solvent | 60 | organohalide solvent | 100 |
| | Plastic source | 40 | p-Styrene | 30 |
| | | | ABS | 70 |
| E2 | Solvent | 60 | aromatic hydrocarbon | 100 |
| | Plastic source | 40 | p-Styrene | 30 |
| | | | ABS | 70 |
| E3 | Solvent | 60 | aromatic hydrocarbon | 20 |
| | | | dearomatised solvent | 80 |
| | Plastic source | 40 | p-Styrene | 30 |
| | | | ABS | 70 |
| E4 | Solvent | 60 | organohalide solvent | 100 |
| | Plastic source | 40 | p-Styrene | 30 |
| | | | EVA | 70 |
| E5 | Solvent | 60 | aromatic hydrocarbon | 100 |
| | Plastic source | 40 | p-Styrene | 30 |
| | | | EVA | 70 |
| E6 | Solvent | 60 | aromatic hydrocarbon | 20 |
| | | | dearomatised solvent | 80 |
| | Plastic source | 40 | p-Styrene | 30 |
| | | | EVA | 70 |
| E7 | Solvent | 60 | organohalide solvent | 100 |
| | Plastic source | 40 | p-Styrene | 30 |
| | | | acrylic | 70 |
| E8 | Solvent | 60 | aromatic hydrocarbon | 100 |
| | Plastic source | 40 | p-Styrene | 30 |
| | | | acrylic | 70 |
| E9 | Solvent | 60 | aromatic hydrocarbon | 20 |
| | | | dearomatised solvent | 80 |
| | Plastic source | 40 | p-Styrene | 30 |
| | | | acrylic | 70 |

The following binder formulations may be prepared. Solvent is added to the plastic source to form the binder mixture.

TABLE 9
Manufacture of the binder prepared from Styrene + two other plastics

| | | % w/w | | % w/w |
|---|---|---|---|---|
| Binder | Class | of total | Component | of class |
| F1 | Solvent | 40 | organohalide solvent | 100 |
| | Plastic source | 60 | p-Styrene | 60 |
| | | | ABS | 20 |
| | | | EVA | 20 |
| F2 | Solvent | 40 | organohalide solvent | 100 |
| | Plastic source | 60 | p-Styrene | 60 |
| | | | ABS | 20 |
| | | | acrylic | 20 |
| F3 | Solvent | 40 | organohalide solvent | 100 |
| | Plastic source | 60 | p-Styrene | 60 |
| | | | EVA | 20 |
| | | | acrylic | 20 |
| F4 | Solvent | 40 | aromatic hydrocarbon | 100 |
| | Plastic source | 60 | p-Styrene | 60 |
| | | | ABS | 20 |
| | | | EVA | 20 |
| F5 | Solvent | 40 | aromatic hydrocarbon | 100 |
| | Plastic source | 60 | P-Styrene | 60 |
| | | | ABS | 20 |
| | | | acrylic | 20 |
| F6 | Solvent | 40 | aromatic hydrocarbon | 100 |
| | Plastic source | 60 | P-Styrene | 60 |
| | | | EVA | 20 |
| | | | acrylic | 20 |
| F7 | Solvent | 40 | aromatic hydrocarbon | 100 |
| | Plastic source | 60 | P-Styrene | 60 |
| | | | ABS | 20 |
| | | | EVA | 20 |
| F8 | Solvent | 40 | aromatic hydrocarbon | 100 |
| | Plastic source | 60 | P-Styrene | 60 |
| | | | ABS | 20 |
| | | | acrylic | 20 |
| F9 | Solvent | 40 | aromatic hydrocarbon | 20 |
| | | | dearomatised solvent | 80 |
| | Plastic source | 60 | P-Styrene | 60 |
| | | | EVA | 20 |
| | | | acrylic | 20 |
| G1 | Solvent | 60 | organohalide solvent | 100 |
| | Plastic source | 40 | P-Styrene | 60 |
| | | | ABS | 20 |
| | | | EVA | 20 |
| G2 | Solvent | 60 | organohalide solvent | 100 |
| | Plastic source | 40 | P-Styrene | 60 |
| | | | ABS | 20 |
| | | | acrylic | 20 |
| G3 | Solvent | 60 | organohalide solvent | 100 |
| | Plastic source | 40 | P-Styrene | 60 |
| | | | EVA | 20 |
| | | | acrylic | 20 |
| G4 | Solvent | 60 | aromatic hydrocarbon | 100 |
| | Plastic source | 40 | P-Styrene | 60 |
| | | | ABS | 20 |
| | | | EVA | 20 |
| G5 | Solvent | 60 | aromatic hydrocarbon | 100 |
| | Plastic source | 40 | P-Styrene | 60 |
| | | | ABS | 20 |
| | | | acrylic | 20 |
| G6 | Solvent | 60 | aromatic hydrocarbon | 100 |
| | Plastic source | 40 | P-Styrene | 60 |
| | | | EVA | 20 |
| | | | acrylic | 20 |
| G7 | Solvent | 60 | aromatic hydrocarbon | 100 |
| | Plastic source | 40 | P-Styrene | 60 |
| | | | ABS | 20 |
| | | | EVA | 20 |
| G8 | Solvent | 60 | aromatic hydrocarbon | 100 |
| | Plastic source | 40 | P-Styrene | 60 |
| | | | ABS | 20 |
| | | | acrylic | 20 |
| G9 | Solvent | 60 | aromatic hydrocarbon | 20 |
| | | | dearomatised solvent | 80 |
| | Plastic source | 40 | P-Styrene | 60 |
| | | | EVA | 20 |
| | | | acrylic | 20 |
| H1 | Solvent | 40 | organohalide solvent | 100 |
| | Plastic source | 60 | P-Styrene | 30 |
| | | | ABS | 35 |
| | | | EVA | 35 |
| H2 | Solvent | 40 | organohalide solvent | 100 |
| | Plastic source | 60 | P-Styrene | 30 |
| | | | ABS | 35 |
| | | | acrylic | 35 |
| H3 | Solvent | 40 | organohalide solvent | 100 |
| | Plastic source | 60 | P-Styrene | 30 |
| | | | EVA | 35 |
| | | | acrylic | 35 |
| H4 | Solvent | 40 | aromatic hydrocarbon | 100 |
| | Plastic source | 60 | P-Styrene | 30 |
| | | | ABS | 35 |
| | | | EVA | 35 |
| H5 | Solvent | 40 | aromatic hydrocarbon | 100 |
| | Plastic source | 60 | P-Styrene | 30 |
| | | | ABS | 35 |
| | | | acrylic | 35 |
| H6 | Solvent | 40 | aromatic hydrocarbon | 100 |
| | Plastic source | 60 | P-Styrene | 30 |
| | | | EVA | 35 |
| | | | acrylic | 35 |
| H7 | Solvent | 40 | aromatic hydrocarbon | 100 |
| | Plastic source | 60 | P-Styrene | 30 |
| | | | ABS | 35 |
| | | | EVA | 35 |
| H8 | Solvent | 40 | aromatic hydrocarbon | 100 |
| | Plastic source | 60 | P-Styrene | 30 |
| | | | ABS | 35 |
| | | | acrylic | 35 |
| H9 | Solvent | 40 | aromatic hydrocarbon | 20 |
| | | | dearomatised solvent | 80 |
| | Plastic source | 60 | P-Styrene | 30 |
| | | | EVA | 35 |
| | | | acrylic | 35 |
| I1 | Solvent | 60 | organohalide solvent | 100 |
| | Plastic source | 40 | P-Styrene | 30 |
| | | | ABS | 35 |
| | | | EVA | 35 |
| I2 | Solvent | 60 | organohalide solvent | 100 |
| | Plastic source | 40 | P-Styrene | 30 |
| | | | ABS | 35 |
| | | | acrylic | 35 |
| I3 | Solvent | 60 | organohalide solvent | 100 |
| | Plastic source | 40 | P-Styrene | 30 |
| | | | EVA | 35 |
| | | | acrylic | 35 |
| I4 | Solvent | 60 | aromatic hydrocarbon | 100 |
| | Plastic source | 40 | P-Styrene | 30 |
| | | | ABS | 35 |
| | | | EVA | 35 |
| I5 | Solvent | 60 | aromatic hydrocarbon | 100 |
| | Plastic source | 40 | P-Styrene | 30 |
| | | | ABS | 35 |
| | | | acrylic | 35 |
| I6 | Solvent | 60 | aromatic hydrocarbon | 100 |
| | Plastic source | 40 | P-Styrene | 30 |
| | | | EVA | 35 |
| | | | acrylic | 35 |
| I7 | Solvent | 60 | aromatic hydrocarbon | 100 |
| | Plastic source | 40 | P-Styrene | 30 |
| | | | ABS | 35 |
| | | | EVA | 35 |
| I8 | Solvent | 60 | aromatic hydrocarbon | 100 |
| | Plastic source | 40 | P-Styrene | 30 |
| | | | ABS | 35 |
| | | | acrylic | 35 |
| I9 | Solvent | 60 | aromatic hydrocarbon | 20 |
| | | | dearomatised solvent | 80 |
| | Plastic source | 40 | P-Styrene | 30 |
| | | | EVA | 35 |
| | | | acrylic | 35 |

Results showing any one or more of the following demonstrates that the above binder formulations are effective.
ITS of the formed product,
ITSM of the formed product,
wettability,
aggregate coverage, and/or
aggregate adhesion.

2.2 Binder C—Hot Road Binder Mix

40 kg of methylene chloride was mixed with 60 kg of dissolvable plastics to form 100 kg of binder. The non-plastic waste streams, oil and paints can be added during this dissolvable process. For example, for 100 kg of binder this uses 80 kg of dissolved plastics and 20 kg of non-plastics (waste oils and paints). We recommended that no more than 20% of the total mix should be non-plastics.

Once all ingredients are mixed, the mixture can be heated to 100° C. to 200° C. degrees under pressure.

The temperature required is determined by the % of non-plastics waste added and also the melting point of the plastics used in the plastics source.

When adding non-plastic streams (e.g. paint, food and engineering oils), which ranges between 5 to 20% maximum, the heating of the combined mix can be varied to suite the transport requirements between batching plant and application at the required location. For example, the distance between the batching plant preparing the emulsion and the site of use (where the road is laid). It is also envisaged this road mix option can also be used in an in situ process.

### 3. Preparation of Roading Formulations

The binder formulations of Table 6 were combined with aggregate to form a roading composition and tested as shown in Table 10.

| | | | % | % | Temp. | | ITSM |
|---|---|---|---|---|---|---|---|
| Sample | Binder | Component | w/w | Fines | (° C.) | ITS (kPa) | (kPa) |
| 1 | Standard | Foamed | 6 | 25 | 180° C. | 400 | 3500 |
| | | bitumen | 94 | | | | |
| | | Aggregate | | | | | |
| | | (Gap 20) | | | | | |
| 2 | A | Binder | 6 | 25 | Ambient | 1900-2100 | 16000-19500 |
| | | Aggregate | 94 | | | | |
| | | (Gap 20) | | | | | |
| 3 | | Binder | 6 | | Ambient | 1450-1850 | 13000-18000 |
| | | Aggregate | 94 | 50 | | | |
| | | (Gap 20) | | | | | |
| 4 | | Binder | 8 | | Ambient | 2100-2300 | 17600-19360 |
| | | Aggregate | 92 | 25 | | | |
| | | (Gap 20) | | | | | |
| 5 | | Binder | 8 | | Ambient | 1600-2050 | 14500-15,950 |
| | | Aggregate | 92 | 50 | | | |
| | | (Gap 20) | | | | | |
| 6 | | Binder | 10 | 25 | Ambient | 2320-2530 | 19400-21400 |
| | | Aggregate | 90 | | | | |
| | | (Gap 20) | | | | | |
| 7 | | Binder | 10 | | Ambient | 1760-2250 | 15950-17600 |
| | | Aggregate | 90 | 50 | | | |
| | | (Gap 20) | | | | | |
| 8 | B-5 | Binder | 10 | | 140-200 | 2400 | 21000 |
| | | Aggregate | 94 | 25 | | | |
| | | (Gap 20) | | | | | |
| 9 | | Binder | 10 | | 140-200 | 2400 | 21000 |
| | | Aggregate | 94 | 25 | | | |
| | | (Gap 20) | | | | | |
| 10 | B-10 | Binder | 10 | | 140-200 | 1000 | 9000 |
| | | Aggregate | 94 | 25 | | | |
| | | (Gap 20) | | | | | |
| 11 | | Binder | 10 | | 140-200 | 1000 | 9000 |
| | | Aggregate | 94 | 25 | | | |
| | | (Gap 20) | | | | | |
| 12 | C-5 | Binder | 10 | | 140-200 | 2000-2400 | 19000- |
| | | Aggregate | 94 | 25 | | (estimated) | 22000 |
| | | (Gap 20) | | | | | (estimated) |
| 13 | | Binder | 10 | | 140-200 | 2000-2400 | 19000- |
| | | Aggregate | 94 | 25 | | (estimated) | 22000 |
| | | (Gap 20) | | | | | (estimated) |
| 14 | C-10 | Binder | 10 | | 140-200 | 2100-2500 | 20000- |
| | | Aggregate | 94 | 25 | | (estimated) | 23500 |
| | | (Gap 20) | | | | | (estimated) |
| 15 | | Binder | 10 | | 140-200 | 2100-2500 | 20000- |
| | | Aggregate | 94 | 25 | | (estimated) | 23500 |
| | | (Gap 20) | | | | | (estimated) |
| 16 | D | Binder | 10 | | Ambient | 1600 | 15800 |
| | | Aggregate | 90 | 25 | | | |
| | | (Gap 20) | | | | | |

As shown in Table 11 below is a binder formulation comprising a monomer mixture.

TABLE 11
Binder formulation comprising monomer.

| Component | Amount |
|---|---|
| p-Styrene | 34.84 |
| Methyl Methacrylate | 47.68 |
| Monomer | |
| 2-EHA Monomer | 15.89 |
| TMPTA | 6.10 |
| DEPT | 2.81 |
| Iron Oxide Black | 0.00 |
| BPO (50% in plasticiser) | 3.76 |
| | 111.08 |

This binder is mixed with wood comprising wood fibre and saw dust to produce a composition comprising about 90% wood products and about 10% binder.

### 4. Example 2—Monomer Based Roading

The purpose of this study was to investigate suitable monomer-based binders for roading application.

In particular this example investigates the use of various monomer mixtures (chloride free) analysing the following.
Can the monomer mixture dissolve poly styrene and other plastics?
What is the viscosity of the monomer mixture and if it is suitable for use in roading application?
What is the curing rate of the monomer mixture when a cross linker is added?
What is a workable amount of promoter and cross linker to be added for curing? And can the rate be altered to suit the requirement in the roading application by altering the amount of cross linker and/or promoter? How much exothermic heat evolved during curing?
What is the strength of the cured polymer?
How the monomer mixture behaves with the actual stone mix used for road making? If it is able to bind the stones, what is the resilient modulus and flexural strength?

A range of monomers were tested being as follows:
P-styrene
MMA—Methyl Methacrylate (used as a hard monomer)
EHA—Ethyl Hexyl Acrylate (used as soft monomer)
TMPTA—Trimethylol propane Triacrylate (used as a crosslinking compound)
Styrene Monomer (hard monomer)
DMPT—N,N-dimethyl-p-toludine (used as promoter for crosslinking)
DEPT (promoter)
BPO—Benzoyl peroxide (used as cross-linking agent/cross linker)

4.1 Base Monomer Mix

A monomer mix was produced in accordance with the formulations of Table 12 and Table 13. Briefly, 800 g of each monomer mix was prepared and mixed in an agitated tank for 15 min.

TABLE 12
Monomer mix “PM2”

| | Quantity, g | Mass % |
|---|---|---|
| P-styrene | 258.5 | 33.3 |
| MMA | 354 | 45.6 |
| 2-EHA | 117.9 | 15.2 |
| TMPTA | 45 | 5.8 |

TABLE 13
Monomer mix “TM2”

| | Quantity, g | Mass % |
|---|---|---|
| P-styrene | 321.6 | 40.2% |
| MMA | 161 | 20.1% |
| Styrene monomer | 161 | 20.1% |
| TMPTA | 156.1 | 19.5% |

100 g of the monomer mix was then manually mixed with a promotor (DPMT) and crosslinker (BPO). The mixture was then subjected to viscosity monitoring in a rotary viscometer (RVDV-1T) to monitor shear rate, viscosity, and temperature at regular intervals, until gelation/solidification. Gelation/solidification is considered as the point at which spindle stops moving and provides no viscosity reading. Spindle #1 was used at an RPM of 100.

The hardness of the solidified mass was measured once the mass cooled down to room temperature, using a Shore hardness tester (shore D Durometer).

The promoter composition was finalised by conducting cure monitoring experiments that varied the amount of promoter at a fixed cross linker composition with the formulations of PM2 and TM2.

The cross-linker composition was then finalised by varying the cross-linker amounts at the finalised promoter composition. The cross linking parameters of gelation time and maximum temperature, and the shore hardness of the respective gelated mass was used.

Promoter composition tested: 0.25, 0.5, 1 and 1.5% to determine the operative range.

Cross-linker composition tested: 1, 1.5 2, 2.5 and 3% at the finalised promoter composition.

Results of the Trials Using TM2

When the polystyrene was added to the rest of monomer mixture, the solution initially became a two-phase mixture and gradually dissolved in the monomer mixture to provide a clear liquid. This was the case with all the monomer mixes analysed.

Shown in Table 14 is the optimised DMPT (promotor) levels at 3% BPO (cross linker). This used 100 g of TM2 and 3 g of BPO.

TABLE 14
Optimising DMPT levels at 3% BPO

| | Promoter (DMPT) % | | | | |
|---|---|---|---|---|---|
| | 0.25 | 0.375 | 0.5 | 1 | 1.5 |
| Gel time (min) | 11.4 | 8 | 5.4 | 4.3 | 1.2 |
| Shore Hardness | 88.5 | 90 | 78.5 | 79.5 | 0 |
| Maximum temperature | 178 | 153.6 | 128 | 120 | 112.8 |
| attained (° C.) | | | | | |

Table 14 demonstrates that as the amount of promoter in the composition is increased, this reduces the maximum temperature attained, indicating a lower extent of cross linking. The time to attain gelation is also reduced as the amount of promotor in the composition is increased.

TABLE 15
Analysis of cross-linker (BPO) at 0.375% promotor (DMPT)

| | Cross-linker (BPO) (% by weight) | | | | |
|---|---|---|---|---|---|
| | 1 | 1.5 | 2 | 2.5 | 3 |
| Gel time, min | 8.4 | 10.26 | 8.5 | 8.5 | 8 |
| Hardness | 24 | 44 | 50 | 76 | 90 |
| Exotherm T (° C.) | 103 | 128 | 150 | 152 | 153.6 |

Table 15 demonstrates that as the amount of cross-linker in the composition increases, the maximum temperature attained increases, indicating a higher extent of cross linking. This was confirmed with shore hardness values where the hardness increased with cross linker composition.

Table 16 shows the result of testing using a combination of 0.375% by weight promotor (DMPT) and 3% by weight of cross-linker (BPO). This study used 100 g of PM2 and 3 g of cross-linker (BPO).

TABLE 16
Analysis of promotor (DMPT) at 3% by weight of cross-linker (BPO)

| | Promoter (DMPT)(% by weight) | | | | |
|---|---|---|---|---|---|
| | 0.25 | 0.375 | 0.5 | 1 | 1.5 |
| Gel time (min) | 23.4 | 13.07 | 11.1 | 6.4 | 4.8 |
| Shore Hardness | 79.5 | 74.3 | 62 | 45 | 29 |
| Maximum temperature | 163.8 | 154.2 | 142.7 | 122.9 | 112.3 |
| attained (° C.) | | | | | |

Table 16 demonstrates that as the amount of promotor is increased, the maximum temperature attained reduces, indicating a lower extent of cross-linking. This was confirmed again with shore hardness values, showing decreased hardness with increasing amounts of promoter in the composition.

TABLE 17
Analysis of cross-linker (BPO) at 0.375% by weight promotor (DMPT)

| | Cross linker BPO (% by weight) | | | |
|---|---|---|---|---|
| | 1 | 1.5 | 2 | 3 |
| Gel time (min) | 24.21 | 22.15 | 17 | 13.07 |
| Hardness | 60 | 45 | 40 | 74.3 |
| Exotherm T (° C.) | 118.2 | 138 | 146.7 | 154.2 |

Table 17 demonstrates that as the amount of cross-linker in the composition is increased, the maximum temperature attained increases, indicating a greater extent of cross-linking.

We further analysed a range of different monomer mixes as shown in Table 18.

TABLE 18
Range of monomers tested

| | | Monomers | | | | |
|---|---|---|---|---|---|---|
| | | P-styrene | MMA | TMPTA | 2-EHA | styrene |
| PT2 | (g) | 258.5 | 426.9 | 90 | | |
| | (%) | 33.3 | | | | |
| PT3 | (g) | 258.5 | | | | |
| | (%) | 33.3 | 49.1 | 17.4 | | |
| TZ | (g) | 120.7 | 322 | 156.1 | | |
| | (%) | 20.25 | 54 | 26.2 | | |
| PM4/ | (g) | 258.5 | | 45 | 472 | |
| PZ | (%) | 33.3% | | 5.8% | 60.9% | |
| PTS2 | (g) | 259 | 191 | 90 | | 191 |
| | (%) | 35.4 | 26 | 12 | | 26 |
| PTS3 | (g) | 259 | 191 | 135 | | 191 |
| | (%) | 33.4 | 24.6 | 17.3 | | 24.6 |
| PTS4 | (g) | 259 | 191 | 157 | | 191 |
| | (%) | 32.4 | 24 | 19.6 | | 24 |

Cure Monitoring Trials

A range of testing was then performed at 3% by weight cross-linker (BPO) and 0.375% by weight promotor (DMPT) for various monomer compositions.

The same procedure as described previously was used for the cure monitoring trials. The formulations of Table 18 were subjected to curing at cross-linker (BPO) and promoter (DMPT) compositions of 3% by weight and 0.375% by weight respectively. The results obtained are shown in Table 19.

Viscosity was tested with spindle #3.

TABLE 19
Resin curing trials at 3% BPO and 0.375 % DMPT for various
monomer compositions

| | | Viscosity | | | |
|---|---|---|---|---|---|
| | Initial | before | Exotherm | | |
| | viscosity | gelation | temper- | Gelation | |
| | (cP) at | (cp) at | ature | time | Hardness |
| Formulation | 100 rpm | rpm 100 | (° C.) | (min) | (Shore D) |
| PZ | 7.71 | 30.9 | 160.3 | 11.45 | 72.5 |
| PM2 | 13.13 | 89.63 | 154.2 | 13 | 74 |
| TZ | 10 | 963.47 | 150.7 | 4.32 | 82.5 |
| | | (rpm: 10) | | | |
| TM2 | 169 | 65 | 153.6 | 8 | 90 |
| | | (rpm: 10) | | | |
| PT2 | 10.3 | 92.07 | 168.8 | 7.20 | 81.7 |
| PT3 | 14.08 | 95.19 | 160.6 | 4.57 | 85.5 |
| PTS2 | 23 | 79.58 | 110 | 40.50 | 75 |
| PTS3 | 19.3 | 63.63 | 160.2 | 13.07 | 80.5 |
| PTS4 | 15.87 | 845.3 | 156.2 | 10.47 | 85.5 |

Table 19 demonstrates the variation of viscosity for various monomer systems at room temperature. As seen, TM2 is highly viscous and visually it was not a free-flowing mixture.

4.2 Preparation of Roading Samples

The roading samples were prepared by using various monomer mixes and a representative stone mix (Stevenson Drury GAP20). The procedure used is given below.
The individual monomer formulations were mixed with the promoter and accelerator (both at finalized amounts of 3% by weight cross-linker [BPO] and 0.375% by weight promotor [DMPT] and a stone mix at a predetermined ratio (8, 10, 12 and 14% by weight of binder). The mixing of the composition was done with a handheld blender. The sequence of addition to the monomer was: addition of promotor (DMPT) first and then addition of the cross-linker (BPO) and the stone mix simultaneously.
The mixed sample was then poured into a mould and manually compressed with a ram. A thermocouple was inserted into the core of the mixture to measure the temperature while curing.
The mould was subjected to a pressure of 1870 kN/m² (15 tons over a mold of 100 mm diameter) to consolidate the mix for 5 min in a pneumatic press.
The mixture was cured in the mold for 30 min and the core temperature monitored (until a constant exotherm was achieved, signaling completion of curing).
The cured sample was removed from the mould and post cured in an electric oven overnight at 65° C.
Representative samples were subjected to resilient modulus testing. Briefly, cylindrical samples of 100 mm diameter and 65 mm height approximate dimensions were used for resilient modulus testing.

Table 20 demonstrates the results from the roading samples made at various binder ratios (8, 10, 12 and 14% by weight).

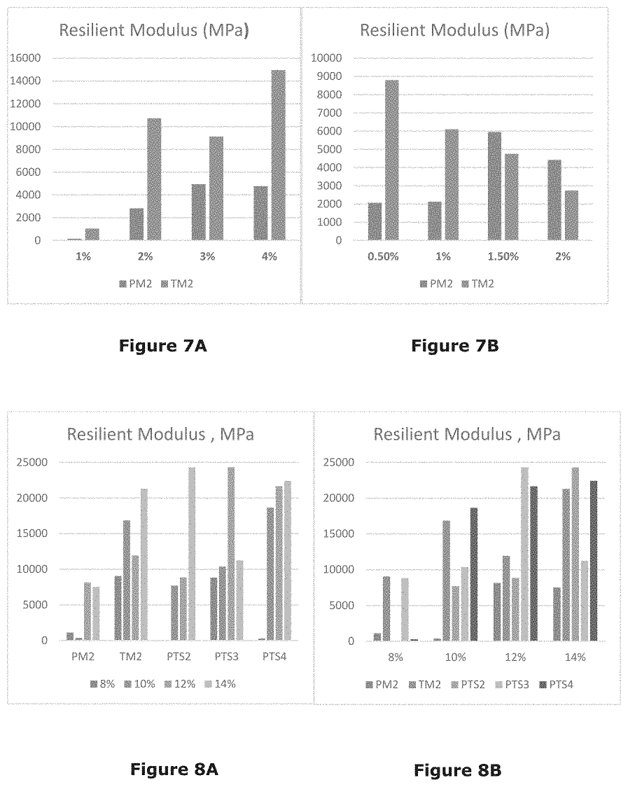

FIG. 7 shows resilient modulus with a) variation of cross linker (BPO) at constant accelerator composition in mix (0.38% DMPT) and b) variation of promotor (DMPT) at constant cross-linker (BPO) in the mix (3%). As cross-linker (BPO) content in mix increases, the resilient modulus also seen to increase. With an increase in promotor (DMPT) levels, resilient modulus is seen to decrease.

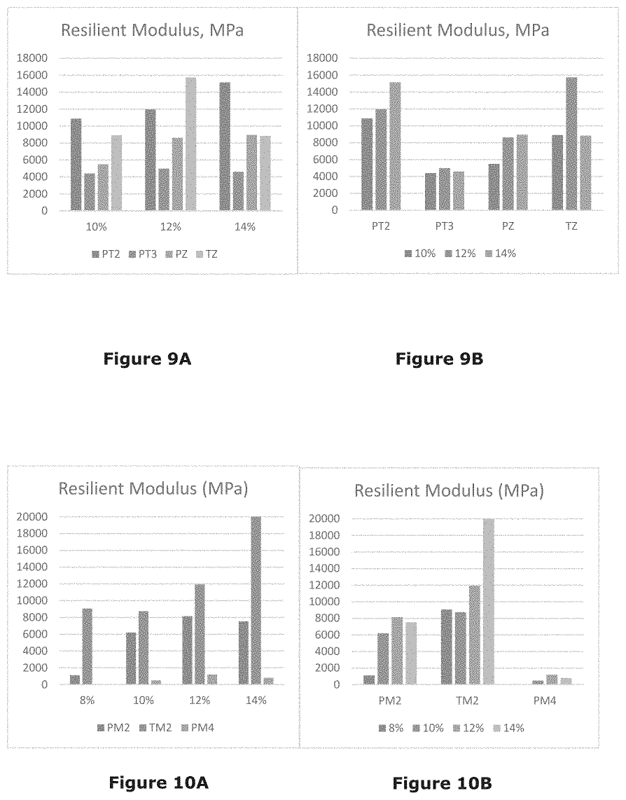

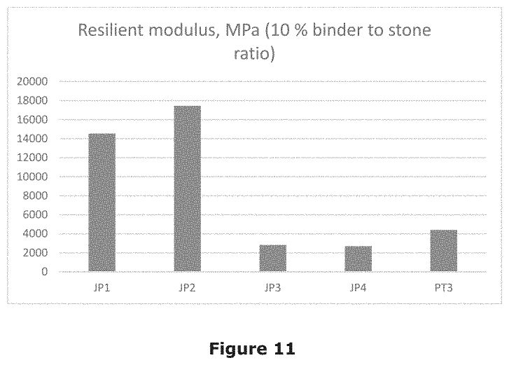

FIGS. 8 to 10 shows the comparison of resilient modulus for various monomer mix at different binder to stone ratios of from other monomer mix considered, PTS4 composition has shown higher resilient modulus and in general resilient modulus increased with increase in binder to stone ratio.

TABLE 20
Comparison of maximum core temperature, resilient
modulus and density for a range of binder % (by weight)

| | | (T | Resilient | |
|---|---|---|---|---|
| | | delta) | modulus | |
| | | (° C.) | (MPa) | Density |
| 8% Binder | PM2 | 2 | 1113 | 2.014 |
| | TM2 | 2 | 9062 | 2.021 |
| | PTS2 | 2 | — | — |
| | PTS3 | 1 | 8827 | 2.168 |
| | PTS4 | 2 | 282 | 1.927 |
| 10% Binder | PM2 | 2 | 376 | 2.014 |
| | TM2 | 1 | 16860 | 2.160 |
| | PTS2 | 2 | 7706 | 2.054 |
| | PTS3 | 2 | 10374 | 2.179 |
| | PTS4 | 3 | 18647 | 2.232 |
| 12% Binder | PM2 | 9 | 8150 | 2.205 |
| | TM2 | 7 | 11932 | 2.191 |
| | PTS2 | 1 | 8862 | 2.035 |
| | PTS3 | 3 | 24312 | 2.228 |
| | PTS4 | 2 | 21649 | 2.201 |
| 14% Binder | PM2 | 9 | 7523 | 2.230 |
| | TM2 | 7 | 21297 | 2.255 |
| | PTS2 | 1 | 24283 | 2.239 |
| | PTS3 | 4 | 11253 | 2.139 |
| | PTS4 | 2 | 22416 | 2.186 |

4.3 Testing of Various Plastics with Monomer System

In this study, the PT3 resin was used, and the polystyrene content was replaced with other plastics (100 g of each resin, 3 g of cross-linker (BPO) and 0.375g of promotor (DMPT).

TABLE 21
Resin curing trials at 3% by weight cross-linker (BPO) and 0.375%
by weight promotor (DMPT) for various plastics with a base PT3
monomer mix

| | | | Exotherm | | |
|---|---|---|---|---|---|
| | Gelation | Viscosity | temper- | | Plastic |
| | time | (cp) at | ature | Hardness | dissolved |
| Resin | (mins) | gelation | (° C.) | (Shore D) | Yes/No |
| JP1 with LDPE | 15 | 100.22 | 108 | 62 | No |
| JP2 with PP | 14.46 | 90.11 | 135 | 80.5 | No |
| JP3 with PET | 11.51 | 100.06 | 145.3 | 86 | No |
| JP4 with HDPE | 13.1 | 100.25 | 132.3 | 75.5 | No |
| PT3 (as it is) | 11.45 | 100.25 | 160.3 | 72.5 | Yes |

The plastics did not dissolve in the monomer system except polystyrene. Curing to form a solid mass was achieved. The roading samples were made at 10% by weight binder to stone mix ratio and the comparison chart is shown in FIG. 11.

These studies demonstrate that an acrylic based monomer mixture can be used for dissolving polystyrene. The flowability/viscosity of the resin can be altered based on the composition to suit the requirement in roading application. Other polymers can replace polystyrene, although may not dissolve and thus may act as a reinforcing filler. The resilient modulus was not compromised (refer FIG. 11).

The curing rate of the monomer mixture can be altered by varying the composition of the promoter and cross-linker to suit the roading application. A cross-linker (e.g. BPO) content of 3% by weight and promotor content (e.g. DMPT) of 0.375% by weight was found to be a useful composition which could be used in roading application.

The maximum exothermic temperature achieved during curing is 160° C. Exothermic heat generated appears to be manageable in the roading application, when it is mixed with stones at room temperature. The maximum temperature increase recorded during core sample making was 9° C. (refer 14% binder of Table 20).

The resilient modulus in general increased with increasing binder to stones ratio. Of the formulations trialled, 14% by weight PTS4 binder with stone mixture has the highest resilient modulus (refer FIG. 8).

### 5. Concrete-Plastic Composite

The concrete-plastic composite were prepared and tested (in-house) using Binder A and (1) crushed concrete waste, or (2) cement slurry, from a commercial batching plant and concrete supply company respectively.

Core samples made from the concrete-plastic composite were tested as shown in Table 22. The results show that, without applying full pressure, a strength of at least 20 Mpa could be achieved. Further samples and testing will be carried out.

TABLE 22
Results from testing the concrete-plastic samples

| | | | Temp. | |
|---|---|---|---|---|
| Binder | Component | % w/w | (° C.) | Mpa |
| A | Binder | 20 | Ambient | 20.5 |
| | Crushed concrete | 80 | | |
| A | Binder | 5 | 140 | To be |
| | Cement slurry | 80 | | tested |
| | <3 mm chipped HDPE | 15 | Estimated | 25 |
| | | | at | |

In comparison:
a mudbrick has an MPa strength of about 1.6 to about 1.9 MPa,
a clay-fired brick has an MPa strength of about 14, and
concrete ranges between 15 and 25 MPa.

### 6. Wood-Plastic Composites—Sample Board Production

This process is carried out for the preparation of composite MDF and particle board products.

6.1 Components

Shown below is the melting point for virgin plastics (Table 23) and waste plastics (Table 24) used.

TABLE 23
Melting point of various virgin plastics

| | Melting point |
|---|---|
| Plastic | (° C.) |
| HDPE-high-density polyethylene | 120 to 180 |
| LDPE-low density polyethylene | 105 to 115 |
| PP-polypropylene (depends on atactic | 160 to 166 |
| material and crystallinity) | |
| Syndiotactic PP (crystallinity of 30%) | 130 |
| Styrenes | 180 and 260 |

TABLE 24
Melting point of various waste plastics

| | Melting point |
|---|---|
| Plastic | (° C.) |
| HDPE-high-density polyethylene | 170-190 |
| LDPE-low density polyethylene | 150-170 |
| Eco Bottles (Sugarcane, known as sugarbio) | ~130 |
| PET-Polyethylene terephthalate | ~260 |
| Polypropylene Paint pails | 160 to 166 |

Styrene/Polystyrene are cold dissolved in the NILO emulsion stage.

Listed below are the fibres used with the plastics referred to above in Table 23 and Table 24.
Hemp
Wood sawdust—industry wood fibre flakes
Shredded paper—Cardboard fibre
PP—Polyethylene Woven Bags
Polyethylene Bags
PET Bottles
Crushed Glass
Crushed Toys-electronics-TV backs-Printer cartridges
Volcanic ash and pot ash
Rubber/Tyres and carbon black (granulated tyres)

A peroxidase based cross linker (Luperox 130 in powder form) was used with the plastics referred to above in Table 23 and Table 24:

6.2 Preparation of Plastic Emulsions

The plastic emulsions were prepared from either virgin or waste plastics, or a mixture of the two.

The binder emulsion was formed from a mixture of styrene, ABS, EVA and acrylic plastics in combination with a solvent. This mixture of plastics was found to produce stiffer wood-plastic composite boards.

Also tested was a hard plastics water-based binder containing polyethylene, HDPEI, ABS and Nylon. This mixture of plastics makes boards that have improved flex and impact resistance.

TABLE 25
Manufacture of the binder for wood-plastic composite

| | | % w/w | | % w/w |
|---|---|---|---|---|
| Binder | Class | of total | Component | of class |
| A | Solvent | 40 | Trichioroethylene | 10 |
| | | | Methylene chloride | 90 |
| | Dissolvable plastics | 60 | Polyethylene | 60 |
| | | | ABS | 15 |
| | | | HDPEI | 15 |
| | | | Nylon | 10 |

The binder and wood fibre was mixed at a ratio of 90% wood fibre and 10% binder and placed into a mould. The mould was heated to a temperature of 200° C.

The degree of compaction may be dependent on the amount of moisture in the ingredients. For example, if pressing 100% dry ingredients (i.e. the <2 mm plastics granules, cross linkers, binding dry fillers) then compact to 100% (i.e. a fully closed mould). If, for example, pressing damp ingredients then the degree of compaction may be about 80 to about 90%. Additionally, the core temperature is raised to about 120 to about 140° C. and then the mould is completely shut.

In some situations, when closing the press, it may appear that there is excess ingredients in the mould. However, it is important to note the binder mix needs time to soften. In one configuration the amount of pressure applied to the mould is increased. For example, in one configuration the mould is initially subjected to 50 tons and, when the plastic starts to soften and the pressure drops, then the mould is closed and the temperature of the mould is raised to about 200° C.

In some configurations the use of cross linkers may change the press cycle. Without wishing to be defined by theory, the presence of cross linkers may stop the plastic from running. In one configuration cross linkers may be used with virgin plastics. In one configuration cross linkers are not used where the plastic source is waste plastic.

In one configuration, the binder is made from a combination of two plastic binder compositions: one being water based and one being solvent based. The binder is then combined with a waste material (e.g. wood fibre materials such as sawdust used in MDF, wood fibre used in particle board, waste materials such as paper and cardboard fibre, granulated rubber, ground glass, other waste unrecyclable plastics such as ocean sourced waste plastics, PP and waste PET, pumice, other volcanic materials, rice and coconut husk). Boards manufactured in this manner lead to a board with high strength.

6.3 Sample 1

This sample relates to a composite board mix with a mould sized as 385 mm wide, 460 mm long and 35 mm deep. The binder comprised the following components.
4.0 kg plastic as <3 mm granules
   1 kg of waste sugarbio
   2 kg of virgin HDPE
   1 kg of HDPE waste
1.0 kg fibre waste (shredded cardboard/paper)
0.02 g cross linkers (for virgin plastics only)(peroxidase based cross-linker such as Luperox 130

The plastic is combined with water in a mixing tank and ground to a fine powder in the water solvent. The consistency is to allow it to be sprayed. The sprayable mixture is then spayed onto the fibre waste and mixed, and then placed into a mould that was subjected to a 100 ton press and heated to achieve a 140 to 180° C. core temperature.

### Testing—Point Load Test AS4068-1993

One board sample, measuring approximately 459×110×35 mm in size, was subjected to the point load test as outlined in AS4068-1993. A steel cylinder of diameter 75 mm and height 60 mm was used to impose a 100 kg load for 5 minutes at ambient temperature.

The deflection was measured prior to the load being applied at the middle of the span (span distance being 370 mm), under load at the 5 minute mark, and again with the load removed after the 5 minutes. The results are shown below:

TABLE 26
Results of point load test on Board 1.

| | No | With Load | Without Load | Maximum | Residual |
|---|---|---|---|---|---|
| | Load | after 5 mins | after 5 mins | Deflection | Deflection |
| Sample | (mm) | (mm) | (mm) | (%) | (%) |
| Board 1 | 267.0 | 264.5 | 266.25 | 0.68 | 0.2 pass |

The results are shown in FIG. 5.

The maximum allowable deflection as per AS4068-1993 is <2.5% which equates to 9.25 mm at a 370 mm span. Test sample 1 passes this requirement with 0.68% or 2.5 mm being lower than that stated. The residual deflection obtained by sample 1 is 0.2% or 0.74 mm which is within the required limits of <0.5% or 1.85 mm based on a span of 370 mm as stated in AS4068-1993.

A further four samples were exposed to a force applied at a speed of 50 mm/min spanning across supports with radius 15 mm at a span of 215 mm to destruction. A summary of the size of the boards is given below:
Board 2 (Impact composite board mix): 459 mm length, 110 mm width and 35 mm thickness.
Board 1 (Impact board paper board): 450 mm length, 380 mm width and 25 mm thickness
Wood fibre board (WB): 450 mm length, 380 mm width and 25 mm thickness

The results are shown in Table 27 for each of the above boards.

TABLE 27
Impact composite Board Mix

| Sample | Load | Extension | Force | | Approx. | |
|---|---|---|---|---|---|---|
| board | (kg) | (mm) | (N) | MPa | MoE | Comments |
| Board 2 | 666.678 | 6.7314 | 6540.11 | 33.42 | 848.45 | Stopped |
| 1(IB) | 722.552 | 5.860 | 7088.24 | 20.15 | 834.10 | No break |
| WB | 684.007 | 8.804 | 6710.11 | 19.07 | 411.09 | No break |

Board 1 (IB) was trimmed to 385 mm (width)×460 mm (length) and 25 mm (depth) which weighed 4 kg.

The impact board was formed from:
3.2 kg plastic as <3 mm granules
   1 kg waste HDPE
   1.7 kg<8 mm HDPE crumb
   0.5 kg virgin HDPE
0.80 kg fibre waste (shredded fine/paper)
0.01 g cross linkers (for virgin plastics only) (peroxidase based cross-linker such as Luperox 130)

The binder-fibre mixture was placed into a mould that was subjected to a 100-ton press and heated to achieve a 180° C. core temperature.

The woof fibre board (WB) was trimmed to 385 mm (width)×460 mm (length) and 21 mm (depth) which weighed 3.2 kg.

Wood fibre board was made using industry supplied wood fibre and bound together using waste plastic granules waster-based binder.
2.0 kg plastic as <3 mm granules
   2 kg waste HDPE
1.1 kg waste wood
   1.0 kg industry wood fibre
   0.1 kg wood dust
0.1 kg of Binder A
0.01 g cross linkers (for virgin plastics only) (peroxidase based cross-linker such as Luperox 130

The binder-fibre mixture was placed into a mould that was subjected to a 100-ton press and heated to achieve a 180° C. core temperature.

Pressing tonnage may depend on the desired strength of the board (and the amount of added material fillers). In one configuration the strength of the board may depend on the amount of added material fillers (which increases the overall weight of the board) and increased tonnage.

The board was subjected to a “drop test”. The Sample 1 board mixture was pressed in a mould at 100 ton and heated to a core temperature of 180° C. The board was subjected to a “dart drop impact test”. The dart drop impact test comprises dropping a 20 kg hemispheric curved metal dart at a desired distance to achieve a required test result.

Board A was cut into 3×100 mm (width), 400 mm (length), 30 mm (depth) parts and subjected to a Dart Drop Impact Test. The dart was dropped from 300 mm to the centre spot of the board. The result observed is that the boards tested did not break.

Once the sample boards in the press reaches the sufficient inner core temperature, the press pressure may be released very slowly following the steps of
99% Hold for 5 sec,
98% hold for 5 sec,
97% hold for 5 sec,
96% hold for 5 sec,
95% hold for 5 sec,
94% hold for 5 sec,
93% hold for 5 sec,
92% hold for 5 sec,
91% hold for 5 sec, and
90% 5 sec then fully open.

This procedure works well with a wet mix as steam builds up and opening to quickly could cause injury also failure of the sample board. Once the board is out, cool down to under 100° C. before taking out the mould.

We claim:

1. A method of manufacturing a plastic-containing emulsion comprising
mixing a plastic source with a solvent in a mixing tank, the solvent selected from a non-reactive solvent or a reactive solvent,
the non-reactive solvent selected from an organohalide solvent, an aromatic hydrocarbon solvent, a mineral spirit, a dearomatised solvent or a combination thereof, and the reactive solvent selected from two or more monoethylenically unsaturated monomers, and
wherein if a non-reactive solvent is used, the plastic source comprises a further plastic that comprises a plastic selected from a styrene copolymer, a copolymer of an alkene and vinyl acetate, acrylic polymer and nylon based polymers or co-polymers, or combination thereof.

2. A method of claim 1 wherein the plastic source is dissolved in the solvent.

3. A method of claim 2 wherein the plastic source is
dissolved prior to its addition into the mixing tank, or
dissolved in the mixing tank.

4. A method of any one of claims 1 to 3 wherein the ratio of plastic source to solvent is between a ratio of 40:60 to 60:40.

5. A method of any one of claims 1 to 4 comprising adding an additive to the mixing tank, wherein the additive accounts for up to 20% of the composition, and is selected from the group consisting of paint, oil, marine waste plastic, propylene-based thermoplastic polymer, homo-polymer of ethylene, organic matter, and any combination thereof.

6. A method of any one of claims 1 to 5 wherein a particulate plastic, having a particle size of less than about 2 mm, is added to the mixing tank, the particulate plastic selected from PET, polypropylene or a polyethylene (including high and low density), or a combination thereof.

7. A method of any one of claims 1 to 6 wherein the particulate plastic accounts for about 15% to about 85% by weight of the total amount of plastic in the binder.

8. A method of claim 7 wherein the particulate plastic is selected from PET, polypropylene or a polyethylene (including high and low density).

9. A method of claim 7 or 8 wherein the particulate plastic has a particle size of less than about 2 mm.

10. A method of any one of claims 1 to 9 comprising a homogenizer in fluid communication with the mixing tank.

11. A method of any one of claims 1 to 10 comprising a solvent recovery system recover solvent from the binder formulation.

12. A method of claim 11 wherein the emulsion comprises less than 30% solvent.

13. A method of any one of claims 1 to 12 comprising combining the emulsion with a coarse aggregate to form a roading mixture, the coarse aggregate having a particle size of less than about 60 mm.

14. A method of claim 13 wherein the ratio of aggregate to binder is about 7 to about 12% binder to aggregate.

15. A method of any one of claims 1 to 14 wherein the roading mixture is absent any bitumen.

16. A method of claim 14 or 15 wherein the mixture is laid onto a roading base course at a thickness of between 50 to about 200 mm.

17. A method of claim 16 wherein the thickness of the road sub-base layer is 120 to 200 mm.

18. A method of claim 16 or 17 wherein the roading process includes a surface layer of plastic.

19. A method of claim 18 wherein the surface layer of plastic is formed from a plastic slurry comprising particulate PET having a particle size of less than 2 mm.

20. A method of claim 18 or 19 wherein the surface layer of plastic is about 50 to about 100 mm in thickness.

21. A method of any one of claims 1 to 20 wherein the plastic source comprises high melt plastic.

22. A method of claim 21 wherein the high melt plastic is selected from polyester-based thermoplastic polymer resin, propylene-based thermoplastic polymer, homo-polymer of ethylene is polyethylene, or a combination thereof.

23. A method of claim 21 or 22 wherein the composition is heated to about 100 to about 200° C.

24. A method of any one of claims 22 to 23 wherein the high melt plastic is selected from ABS, nylon, EVA or acrylic, or a combination thereof.

25. A method of any one of claims 23 to 24 wherein the high melt plastic is selected from polyethylene, polypropylene, nylon, or a combination thereof.

26. A method of manufacturing a plastic-composite product comprising
mixing a binder and a particulate or fibrous substrate to produce a mouldable mixture, the binder comprising a plastic source and a solvent, the binder comprising
i) a plastic source selected from polyester-based thermoplastic polymer resin, propylene-based thermoplastic polymer, a homo-polymer of ethylene, or a combination thereof, having a particle size of less than 8 mm, and water as a solvent,
ii) a plastic source comprising at least 30% by weight of total plastic of a plastic that contains a styrene unit and up to 70% by weight of total plastic of a plastic source selected from a styrene copolymer, a copolymer of ethylene and vinyl acetate, acrylic polymer and nylon based polymers or co-polymers, and a solvent selected from an organohalide solvent, an aromatic hydrocarbon solvent, a mineral spirit, a dearomatised solvent or a combination thereof, or
iii) a combination of (i) and (ii);
placing the mouldable mixture into a mould, and
compressing the mixture to produce the plastic-composite product.

27. A method of claim 26 wherein the plastic source has an average particle size of less than 8 mm.

28. A method of claim 26 or 27 wherein the particulate or fibrous substrate has a particle size of less than about 50 mm.

29. A method of any one of claims 26 to 28 wherein the particulate or fibrous substrate is selected from wood particles (e.g. sawdust or wood fibres or flakes), shredded paper or cardboard fibre, shredded polyethylene woven bags, shredded polyethylene bags, chipped PET bottles, crushed Glass, crushed consumables (e.g. crushed plastic toys, electronics, printer cartridges), volcanic ash and pot ash, granulated rubber, granulated tyres or a combination thereof.

30. A method of any one of claims 26 to 29 wherein the mould is heated to at least 100° C.

31. A method of any one of claims 1 to 30 wherein the styrene copolymer is acrylonitrile butadiene styrene (ABS).

32. A method of any one of claims 1 to 31 wherein the copolymer of ethylene and vinyl acetate is ethylene-vinyl acetate (EVA).

33. A method of any one of claims 1 to 32 wherein the acrylic polymer is poly(methyl methacrylate).

34. A method of any one of claims 1 to 33 wherein the nylon based polymers or co-polymers is Nylon.

35. A method of any one of claims 1 to 34 wherein the polyester-based thermoplastic polymer resin is polyethylene terephthalate (PET).

36. A method of any one of claims 1 to 35 wherein the propylene-based thermoplastic polymer is polypropylene (PP).

37. A method of any one of claims 1 to 36 wherein the homo-polymer of ethylene is polyethylene (PE)(including high and low density polyethylene).

38. A method of any one of claims 1 to 37 wherein the organohalide solvent is selected from methyl chloride, methylene chloride or trichloroethylene, or a combination thereof.

39. A method of any one of claims 1 to 38 wherein the aromatic hydrocarbon solvent is selected from toluene or xylene, or a combination thereof.

40. A method of any one of claims 1 to 39 wherein the dearomatised solvent is selected from Exxsol™ D40, Exxsol™ D60, Exxsol™ D80 or Exxsol™ D100, ShellSol D60, or a combination thereof.

41. A composite product formed from the method of any one of claims 26 to 40.

42. A composite product of claim 41 wherein the composite product is a concrete-composite product, a wood-based composite product.

43. A composite product of claim 42 wherein the wood-based composite product is selected from plywood, particle board, and medium density board.

44. A method of any one of claims 42 to 43 wherein the composite product is a panel, post or block.

45. A method of manufacturing a road comprising
providing a binder comprising,
a plastic source comprising at least 30% by weight of total plastic of a plastic that comprises a styrene unit,
an acrylate monomer,
a cross-linker, and
combining the binder with an aggregate to coat said aggregate,
laying the mixture onto a roading base course at a thickness of between 50 to about 200 mm; and
compacting the layer.

46. A method of claim 45 wherein the binder further comprises a styrene monomer.

47. A method of claim 45 or 46 wherein the binder further comprises a promotor.

48. A method of any one of claims 45 to 47 wherein the styrene monomer is polystyrene.

49. A method of any one of claims 45 to 48 wherein the acrylate monomer is selected from a soft monomer.

50. A method of any one of claims 45 to 48 wherein the acrylate monomer is selected from a hard monomer.

51. A method of any one of claims 45 to 50 wherein the plastic source is present at about 30 to about 50% by weight of the binder.

52. A method of any one of claims 45 to 51 wherein the binder comprises about to about 70% by weight of a monomer.

53. A method of any one of claims 45 to 52 wherein the binder comprises about 5 to about 30% by weight of a cross-linker.

54. A method of any one of claims 45 to 53 wherein the binder comprises about 0.25 to 0.5% by weight of promotor.

55. A method of any one of claims 45 to 54 wherein the binder additional comprises a peroxide cross-linker.

56. A method of claim 55 wherein the peroxide cross-linker is present at about 2 to about 5% by weight of the binder.

57. A method of claim 55 or 56 wherein the peroxide cross-linker is selected from a benzoyl peroxide.

58. A method of any one of claims 45 to 57 wherein the binder is mixed with an aggregate, wherein the binder comprises about 8 to about 16% by weight of the total mixture.
